(19) United States
(12) Patent Application Publication
(10) Pub. No.: US 2024/0294120 A1
(43) Pub. Date: Sep. 5, 2024

(54) DUAL DIRECTION REVERSABLE HITCH ARM

(71) Applicant: Hitch Fire Inc., Soquel, CA (US)

(72) Inventor: Evan Michael Currid, Santa Cruz, CA (US)

(21) Appl. No.: 18/647,583

(22) Filed: Apr. 26, 2024

Related U.S. Application Data
(63) Continuation-in-part of application No. 17/655,766, filed on Mar. 21, 2022.
(60) Provisional application No. 63/498,456, filed on Apr. 26, 2023.
(60) Provisional application No. 63/501,457, filed on May 11, 2023.
(60) Provisional application No. 63/163,255, filed on Mar. 19, 2021.

(51) Int. Cl. B60R 9/06

(52) U.S. Cl. CPC B60R 9/065

(57) ABSTRACT

A hitch-mountable grill and swing arm system is described. A system may include a swing arm that pivots at a first end and includes one or more accessory mounting points toward a second end. A system may include a hitch arm couplable with a hitch receiver of a vehicle in at least two orientations, the hitch arm having an elbow that extends to one or more of a left side and a right side of the vehicle when the hitch arm is coupled to the vehicle. A system may include a hinge mechanism coupled with the swing arm and allowing the swing arm to pivot about an axis of rotation formed by the hinge mechanism, the hinge mechanism being detachably coupleable with the hitch arm in the at least two orientations of the hitch arm.

### BACKGROUND

The present disclosure relates to grills and other automotive trailer hitch-mounted accessories. For instance, the present disclosure relates to a reversible swing arm that may couple accessories, such as a grill, to a vehicle's hitch.

Many outdoors enthusiasts enjoy transporting various accessories, such as barbeque grills, with them on their vehicle, so that they can cook while camping or tailgating. Typical portable grills take up significant amounts of space inside a vehicle or are too small or compromised to provide a good cooking experience. Previous grills, however, may not be properly adapted to mount to trailer hitches, may not support interchangeability and adaptability, or are not strong enough to handle prolonged stresses of being mounted to a trailer hitch.

Unfortunately, various vehicles have tailgates, hatches, or doors that open in different directions, so a static mounting mechanism that does not move or only moves in a single direction fails to be sufficiently adaptable to be used with various vehicles, parking situations, or preferences.

Accordingly, there is a need among such trailer-hitch accessories to improve style, adaptability, ease of use, and utility.

### SUMMARY

A hitch-mountable grill and swing-arm system can be configured to have various configurations. In some aspects, the techniques described herein relate to a reversible swing-arm system including: a swing arm that pivots at a first end and includes one or more accessory mounting points toward a second end; a hitch arm couplable with a hitch receiver of a vehicle in at least two orientations, the hitch arm having an elbow that extends to one or more of a left side and a right side of the vehicle when the hitch arm is coupled to the vehicle; and a hinge mechanism coupled with the swing arm and allowing the swing arm to pivot about an axis of rotation formed by the hinge mechanism, the hinge mechanism being detachably coupleable with the hitch arm in the at least two orientations of the hitch arm.

In some aspects, the techniques described herein relate to a reversible swing-arm system, wherein the swing arm includes: a riser at the second end, the riser extending vertically upward when the reversible swing-arm system is mounted to the vehicle in each of the at least two orientations.

In some aspects, the techniques described herein relate to a reversible swing-arm system, wherein the swing arm includes: the one or more accessory mounting points integrated with the swing arm, the one or more accessory mounting points allowing one or more accessories to be mounted to the swing arm in addition to a device coupled with the swing arm at the riser.

In some aspects, the techniques described herein relate to a reversible swing-arm system, wherein the swing arm includes a hinge coupling portion at the first end, the hinge coupling portion pivoting about a post integrated in the hinge mechanism and extending upward from the hitch arm when the reversible swing-arm system is mounted to the vehicle in each of the at least two orientations.

In some aspects, the techniques described herein relate to a reversible swing-arm system, wherein the hitch arm inserts into the hitch receiver of the vehicle at a first end of the hitch arm and detachably couples with the hinge mechanism at a second end of the hitch arm.

In some aspects, the techniques described herein relate to a reversible swing-arm system, wherein the elbow of the hitch arm statically maintains the hitch arm in a substantially L-shaped configuration.

In some aspects, the techniques described herein relate to a reversible swing-arm system, wherein the hitch arm includes: a sleeve at an end of the hitch arm into which a portion of the hinge mechanism inserts.

In some aspects, the techniques described herein relate to a reversible swing-arm system, wherein: the hinge mechanism includes a first hole; the sleeve includes a second hole; and the reversible swing-arm system includes a security bolt simultaneously extending through the first hole and the second hole to secure the hinge mechanism to the sleeve.

In some aspects, the techniques described herein relate to a reversible swing-arm system, wherein the sleeve includes a first mounting plate oriented in a substantially perpendicular direction to a length of the sleeve, the first mounting plate detachably coupling with a second mounting plate of the hinge mechanism.

In some aspects, the techniques described herein relate to a reversible swing-arm system, wherein: the hitch arm includes a tube with a bend forming the elbow, the hitch arm including a first end that inserts into the hitch receiver of the vehicle and a second end that is detachably coupleable with the hinge mechanism; the hinge mechanism is coupled with the swing arm in each of the at least two orientations in a configuration that causes a coupling mechanism of the hinge mechanism to be located vertically lower than the swing arm; and the coupling mechanism is coupled with the second end of the hitch arm in each of the at least two orientations.

In some aspects, the techniques described herein relate to a reversible swing-arm system, further including: a storage container coupled with a vertical riser of the swing arm, the storage container including a case and a lid.

In some aspects, the techniques described herein relate to a reversible swing-arm system, further including: an accessory module inserted into the case of the storage container, the accessory module including a burner and a sink basin.

In some aspects, the techniques described herein relate to a reversible swing-arm system, wherein: the hitch arm includes a tube with a bend forming the elbow, the hitch arm including a first end that inserts into the hitch receiver of the vehicle and a second end that is detachably coupleable with the hinge mechanism.

In some aspects, the techniques described herein relate to a reversible swing-arm system, further including: a platform coupled with a vertical riser of the swing arm, the one or more accessory mounting points including the vertical riser; and one or more side tables slidably coupled with the platform, the one or more side tables sliding under the platform in a storage position and sliding horizontally out from under the platform in a deployed position.

In some aspects, the techniques described herein relate to a reversible swing-arm system, wherein the one or more side tables include an integrated gas burner.

In some aspects, the techniques described herein relate to a hitch-mountable system including: a swing-arm system including: a swing arm that pivots at a first end and includes one or more accessory mounting points toward a second end; a hitch arm couplable with a hitch receiver of a vehicle in at least two orientations, the hitch arm having an elbow that extends to one or more of a left side and a right side of the vehicle when the hitch arm is coupled to the vehicle; and a hinge mechanism coupled with the swing arm and allowing the swing arm to pivot about an axis of rotation formed by the hinge mechanism, the hinge mechanism being detachably coupleable with the hitch arm in the at least two orientations of the hitch arm; and one or more accessories coupled with the swing-arm system at the one or more accessory mounting points, the one or more accessories including one or more of a storage container, a grill, a camp kitchen, and a horizontal platform forming a table.

In some aspects, the techniques described herein relate to a hitch-mountable system, wherein the swing arm includes: a riser at the second end, the riser extending vertically upward when the swing-arm system is mounted to the vehicle in each of the at least two orientations.

In some aspects, the techniques described herein relate to a hitch-mountable system, wherein the hitch arm includes: a sleeve at an end of the hitch arm into which a portion of the hinge mechanism inserts.

In some aspects, the techniques described herein relate to a hitch-mountable system, wherein: the hinge mechanism includes a first hole; the sleeve includes a second hole; and the swing-arm system includes a security bolt simultaneously extending through the first hole and the second hole to secure the hinge mechanism to the sleeve.

In some aspects, the techniques described herein relate to a hitch-mountable system, wherein the sleeve includes a first mounting plate oriented in a substantially perpendicular direction to a length of the sleeve, the first mounting plate detachably coupling with a second mounting plate of the hinge mechanism.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A illustrates an example grill system mounted to a vehicle and pivoted to an open position.

FIGS. 1B and 1C illustrate an example grill system mounted to a vehicle and pivoted to a closed position.

FIG. 1D illustrates an example grill system with example accessories mounted thereto.

FIG. 2A illustrates an example implementation of a grill system decoupled from a swing arm and vehicle.

FIG. 2B illustrates an example implementation of a grill system from a bottom-up perspective and detached from a swing-arm system and vehicle.

FIG. 2C illustrates an example grill system and swing-arm system with one or more example pivot locks.

FIG. 2D illustrates an example swing-arm system with one or more accessory mounting points.

FIG. 2E illustrates an example accessory coupler.

FIG. 2F illustrates an example accessory table.

FIGS. 2G and 2H illustrate an example implementation of a reversible swing-arm system.

FIGS. 2I-2K illustrate an example implementation of a reversible swing-arm system.

FIG. 3A illustrates an example swing-arm system and vehicle hitch receiver.

FIG. 3B illustrates an example swing-arm system decoupled from a grill body and from a vehicle.

FIGS. 3C and 3D illustrate an example grill mounting member.

FIGS. 4A-4E illustrate an example reversible swing arm in a left-handed configuration.

FIG. 4F-4H illustrate an example reversible swing-arm system in a right-handed configuration.

FIG. 5A illustrates an exploded view of various components of an example reversible swing-arm system.

FIG. 5B illustrates an example swing arm assembly where a swing arm is coupled with a reversible hinge mechanism.

FIG. 5C illustrates an example swing arm.

FIG. 5D illustrates an example hitch arm.

FIG. 5E illustrates an example swing lock.

FIGS. 5F-5G illustrate a perspective and exploded view of a reversible hinge mechanism.

FIGS. 6A and 6B illustrate an example implementation of a reversible swing-arm system.

FIG. 6C illustrates a perspective view of an example hitch arm.

FIG. 6D-6F illustrate an example reversible hinge assembly or mechanism.

FIGS. 7A-7D illustrate an example hitch-mounted adaptable kitchen system.

FIG. 7E illustrates an example kitchen system or storage container without any accessory modules installed therein.

FIGS. 7F-7G illustrate an example hitch-mounted adaptable kitchen system.

FIGS. 8A-8D illustrate an example accessory module for a kitchen system.

FIGS. 9A-9D illustrate example implementations of a hitch-mountable platform or cook station with integrated sliding accessories or tables.

### DETAILED DESCRIPTION

The present disclosure describes an innovative technology relating to an adaptable trailer-hitch mountable grill system 102 (hereinafter “grill system”) that may be coupled to automobiles or other vehicles, for example. The grill system 102 may include a grill body 104, a chassis system 106 holding the grill body 104, a swing-arm system 108 coupling the grill body 104 to a trailer hitch, preparation tables 110a and 110b coupled with the grill body 104 and/or chassis system 106, and/or other components described herein. The grill system 102 may also include various accessories, such as a cutting board coupled with the swing-arm system 108. The grill system 102 may include the swing-arm system 108 or may be separate therefrom. Some implementations include other swing-arm system 108 accessories than a grill, such as a kitchen, storage container, platform, or other devices.

The grill system 102 described herein provides increased strength and decreases movement and vibration, also referred to herein as slop, in the grill system 102 to improve its performance coupled to the exterior of a vehicle, for example, via a trailer hitch. For instance, significant forces may be exerted on a trailer hitch mounted grill, accessory, or other device, thereby causing the device to rattle, squeak, or even break. The grill system 102 reduces this slop, thereby improving portability, durability, and overall performance. For example, the chassis system 106, swing arm system 108, grill body 104, or preparation/side tables 110, etc., may be under tension/compression to prevent movement, as described below.

The grill system 102 also provides adaptability, for instance, by allowing the grill body 104 to be mounted on the left or the right side of a vehicle; by adjusting to various heights and angles; by allowing additional accessories to be mounted to a swing arm 114, grill body 104, or chassis system 106; by allowing the chassis and/or grill body 104 to be replaced on the swing arm 114 (e.g., a tower or vertical member of the swing arm 114) by additional or alternative accessories (e.g., a table, umbrella, seat, cutting board, etc.); and other features. These and other advantages are described in further detail below.

Various implementations of the technologies described herein may include a reversible swing-arm system 108. For instance, the system 108 may include a swing arm 114 hingeably coupled with a hitch arm 112. The swing arm 114 may be coupled with and support devices, such as a grill, kitchen, platform, storage container, or otherwise. The hitch arm 112 may be coupleable with (e.g., insertable into) a hitch receiver of a vehicle. Various implementations of the swing-arm system may include various mechanisms for reversing the direction of swing, for example, toward the right or left of a vehicle when mounted to the vehicle. Accordingly, the reversible swing-arm system 108 may provide adaptability to vehicles with a rear door/hatch/tailgate that opens down, right, left, or upward. Similarly, this technology improves adaptability for various accessories (external or mounted to the swing-arm system 108) parking or tailgating scenarios.

In some implementations, the reversible swing-arm system 108 may include a reversible hinge mechanism that couples the swing arm 114 to the hitch arm 112 in multiple orientations. For instance, the hitch arm 112 can be mounted to a hitch receiver to extend either to the left or the right. Similarly, the swing arm 114 may be coupled with the hitch arm in either orientation via the reversible hinge mechanism.

Accordingly, the various implementations of the reversible swing-arm system 108 may remedy the deficiencies of the Background in a robust, secure, and adaptable way.

For example, some implementations of the grill system 102 include an accessory that may be mounted to the swing-arm system 108, which may include a hitch arm 112 and a swing arm 114, among other components described below. Various accessories and systems may be coupled with a hitch of a vehicle via the swing-arm system 108. For instance, a grill, storage container, kitchen, sink, burner, platform, or other device may be mounted to a tower of the swing-arm system 108. In some implementation, additional accessories, such as a table or cutting board may be detachably mounted to a hitch arm 112, so that when the swing arm 114 and grill are pivoted away from the hitch arm 112, the cutting board would be adjacent to the grill body 104 and/or preparation table(s) 110. Beneficially, because the swing arm system 108 allows the tower or vertical portion 128 to remain vertically oriented in various configurations (e.g., in a left- or right-handed swinging configuration), the same devices and accessories can be used with the system or even remain attached to the swing arm 114 or portions thereof.

With reference to the figures, reference numbers may be used to refer to components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

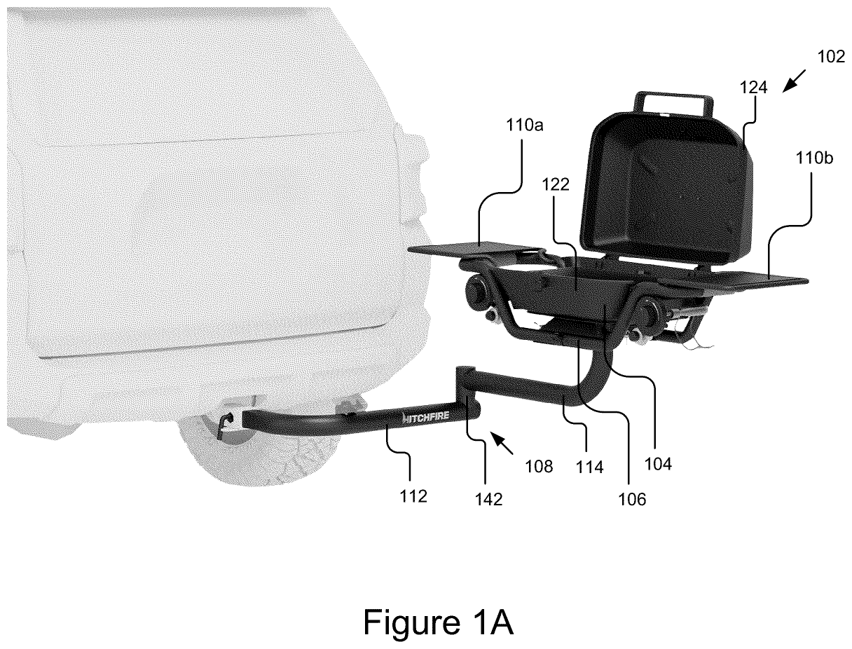

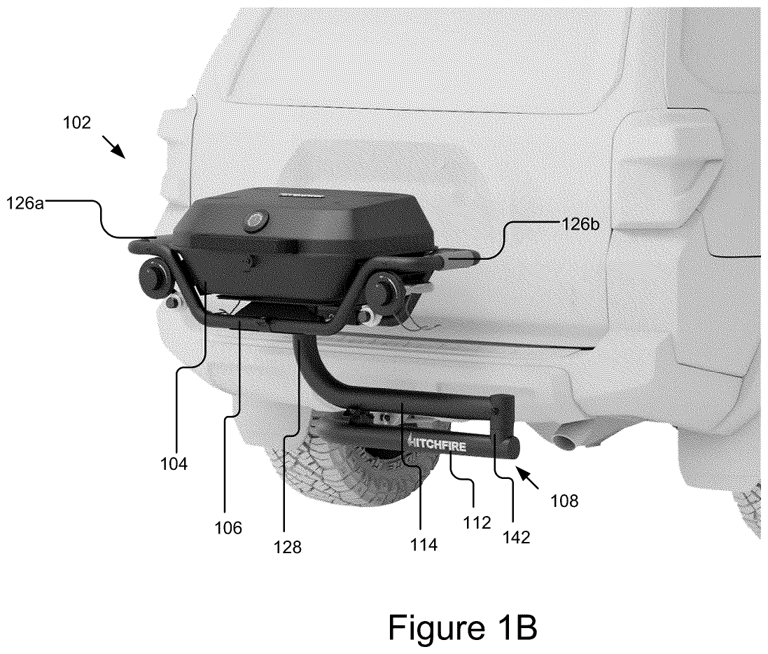

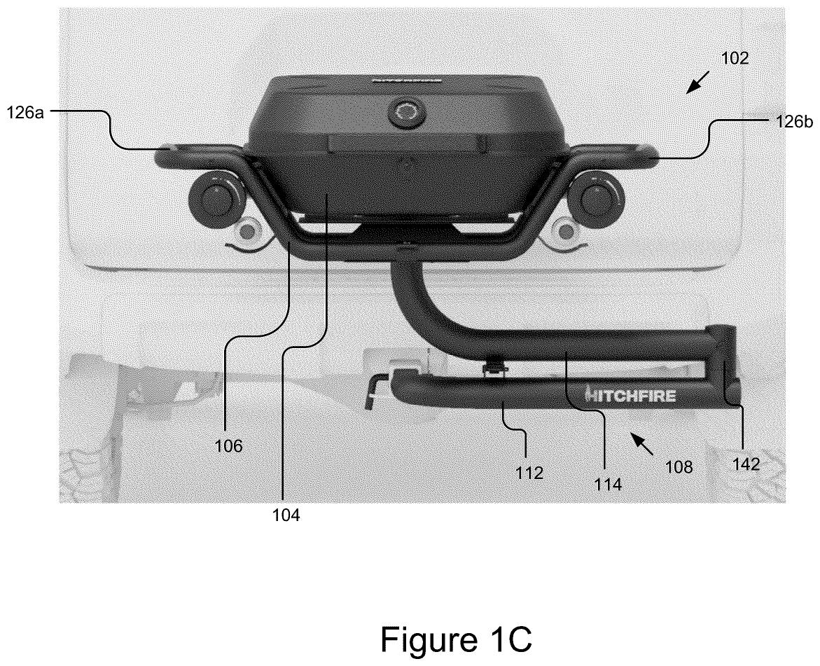

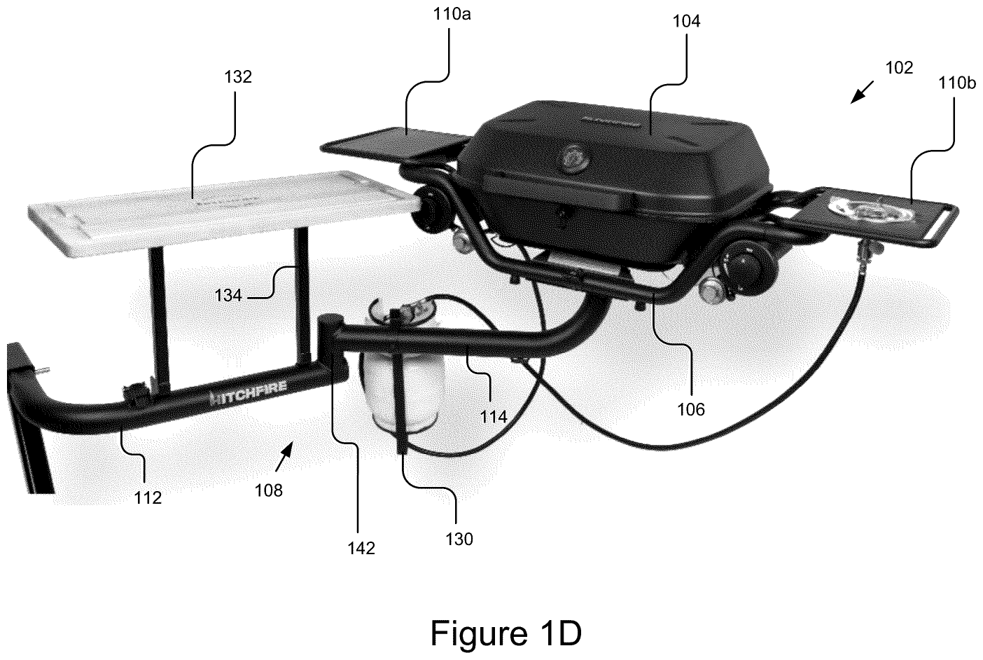

FIG. 1A illustrates an example grill system 102 mounted to a vehicle and pivoted to an open position, for example, where a swing arm 114 is pivoted away from the vehicle and hitch arm 112. FIGS. 1B and 1C illustrate an example grill system 102 mounted to a vehicle and pivoted to a closed position, for example, where the swing arm 114 is pivoted near the vehicle and hitch arm 112. As illustrated, the grill system 102 may be mounted to a trailer-hitch receiver of a vehicle.

In the illustrated example, the grill system 102 may include a grill body 104, a frame or chassis, fold-out preparation tables 110/surfaces, carrying handles 126, a swing-arm system 108, and/or other components, as described herein. For example, a grill body 104 may include a base 122 and a hood 124 enclosing an interior cavity in which a heating element is enclosed. Although a certain configuration of gas barbeque grill is described, it should be noted that other shapes, configurations, or devices are possible in place of the example grill body 104. For instance, the grill body 104 may additionally or alternatively include a storage container, a sink, a burner, a grill grate, platform, or other components. Similarly, although a gas grill is described, it may include propane, natural gas, electric, induction, or other types of heating elements.

As illustrated in the example implementation, a frame or chassis system 106 (also referred to herein simply as “chassis” 106) may be coupled with the grill body 104 thereby providing various benefits, such as strength, handles, legs, mounting points, etc., as described in further detail below. For instance, chassis 106 may include an adapter plate 222 coupling the chassis 106 to the base 122 of the grill body 104. The chassis 106 may also include one or more handles 126a and 126b, which may be used to lift the grill body 104 from the swing-arm system 108 and one or more pads, bars, or legs on which the chassis 106 may rest when not on the swing-arm system 108.

As illustrated in the example implementation, the grill system 102 may also include a swing-arm system 108, which includes a hitch arm 112 coupled with/couplable to a hitch receiver of a vehicle and a swing arm 114 coupled to the hitch arm 112 by a pivot mechanism 142. The hitch arm 112 may include a receiver lock that secures an end of the hitch arm 112 with a vehicle hitch receiver. In some implementations, the swing-arm system 108 may also include one or more pivot locks 238 and/or swing-arm releases that stop rotation of the pivot mechanism 142, for example, by locking the pivot mechanism 142 and/or securing the swing arm 114 adjacent to the hitch arm 112.

In some implementations, the swing arm 114 may include a vertical portion 128 (e.g., a separate or integrated tower) that couples with the chassis 106, adapter plate 222, and/or grill base 122, although other implementations are possible and contemplated herein.

In some implementations, as illustrated below, one or more of the hitch arm 112 and the swing arm 114 may include accessory mounting points adapted to mount accessories, such as tables, cutting boards, or other devices to the swing-arm system 108 separate to the grill body 104 or chassis 106.

These and other features are illustrated and described in further detail below. It should be noted that the provided implementations are examples and that other configurations are possible and contemplated herein.

FIG. 1D illustrates an example grill system 102 with example accessories mounted thereto. For example, FIG. 1D illustrates an example accessory cutting board mounted to a hitch arm 112, an example burner coupled with an example side preparation table 110, and an example propane tank holder 130.

For example, FIG. 1D illustrates an accessory table 132 that couples with the swing-arm system 108. For instance, the accessory table 132 may be coupled with the swing-arm system 108 via an accessory mounting bracket, which may include one or more elongated poles or table legs 134 that insert into, are integrated with, or couple with accessory mounting bracket(s), which couple the table legs 134 with the swing arm 114 and/or hitch arm 112. In some implementations, the legs or brackets of the accessory table 132 may slide within a sleeve or otherwise couple with the hitch arm 112, for example, at accessory mounting points. The accessory mounting points may include screw holes, protrusions, channels, or other structures for coupling with the leg(s) or accessory mounting bracket(s), as described in further detail below. In some implementations, a leg or accessory mounting bracket may be hinged or adjustable in order to level the accessory table 132, for example, when the vehicle is parked on non-level surface. The accessory table 132, cutting board, and other accessories are described in further detail below.

FIG. 1D also illustrates an example propane tank mounting bracket 130. For instance, the tank mounting bracket 130 may couple with the swing arm 114 proximate to the grill. In some instances, the tank mounting bracket 130 may hang to one side (e.g., with a J shape, as shown) of the swing arm 114 so that it does not interfere with the hitch arm 112 when the swing arm 114 is in a storage/closed position over the hitch arm 112.

In some implementations, the hood 124, base 122, chassis 106, preparation tables 110, etc., may include other brackets, coupling points, screw holes, etc., that allow additional accessories to be permanently or temporarily attached to the grill system 102 and/or swing-arm system 108. For example, a cutting board, umbrella, fan, or other accessory may be attached.

In some implementations, the grill system 102 may include one or more bottle openers for opening beverage or food containers. For example, a bottle opener may be attached to or integrated into the chassis 106 (e.g., on the frame), which may provide significant structural rigidity, as described above, thereby allowing bottles to be more easily opened. Similarly, the swing arm 114, chassis 106, or preparation tables may include one or more cup/bottle holders for securely holding beverage containers even when the grill or swing-arm system 108 are not level or are moving (e.g., when the swing arm 114 is being adjusted about the pivot). For instance, one or more cup holders may be attached or integrated into the top or sides of the swing arm 114, so that someone using the grill may store a cup or bottle in a cup holder and pivot the grill without worrying that the bottle will tip or fall, for example, from a preparation table 110.

Although the grill system 102 is illustrated as using propane, in some implementations, the grill system 102 and/or swing-arm system 108 may include electrical components, such as a power strip, whip, or plugs integrated into or attached to the swing arm 114, chassis 106, grill body 104, preparation table 110, etc. For instance, the electrical components may power smartphone chargers, speakers, lights, fans, portable refrigerators, etc., for example, using a hitch power plug-in, a high-voltage power output (e.g., of an electric vehicle), 12 v electrical socket, USB outlet, etc., of a vehicle or generator. For example, the electrical components may include a wiring harness, wires, plugs, inverters, etc., that travel inside, are attached to, and/or exit the swing arm 114 near the vehicle and have an electrical (e.g., USB port, 120-volt outlet, etc.) near the grill on the swing arm 114 (e.g., on the tower). In some implementations, the electrical components may be integrated into the chassis 106, grill body 104, or preparation tables 110. The wiring may pass between the chassis 106 and swing-arm system 108 (e.g., connected via plug inside, integrated with, or adjacent to the tower) to the power source at the vehicle.

In some implementations, a grill heating element may be electric and powered via this connection to the vehicle. For example, electric vehicles with large batteries may provide a power output (e.g., from the bed of an electric pickup truck) that runs the grill and other accessories electrically coupled with the electrical components of the grill system 102 and/or swing-arm system 108.

In some implementations, a component of the swing-arm system 108 and/or grill system 102 may house or couple to a battery to power the electrical components. Similarly, as described below, the heat of the grill may power a battery or one or more electrical accessories.

In some implementations, the grill system 102 may include integrated or attachable lighting. For example, an LED or other light may be integrated with the hood 124, so that when the hood 124 is opened, the light shines on the grill surface and/or preparation tables 110. In some implementations, the light may be powered by the wire harness described above, a battery, or the heat of the grill. For instance, the light may be powered by a BioLite® thermopile, Peltier generator, or other thermoelectric generator, which could also be used to power other electronics such as a smart phone, fan, or speaker.

In some implementations, the light could be integrated into the handle 126 which may include a protrusion or extendable portion or be shaped to allow the light to shine onto the grill surface when the hood 124 is open.

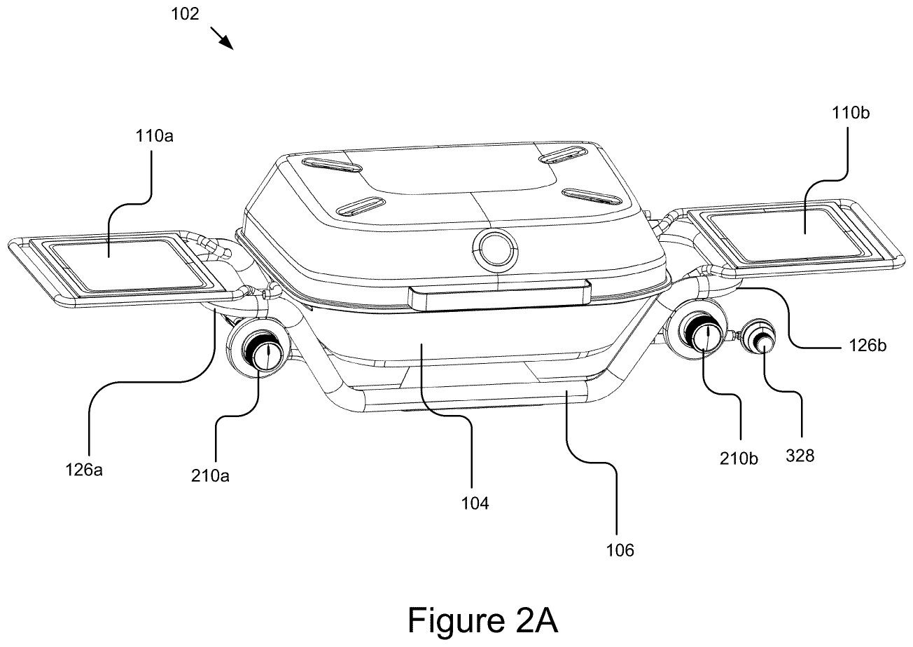

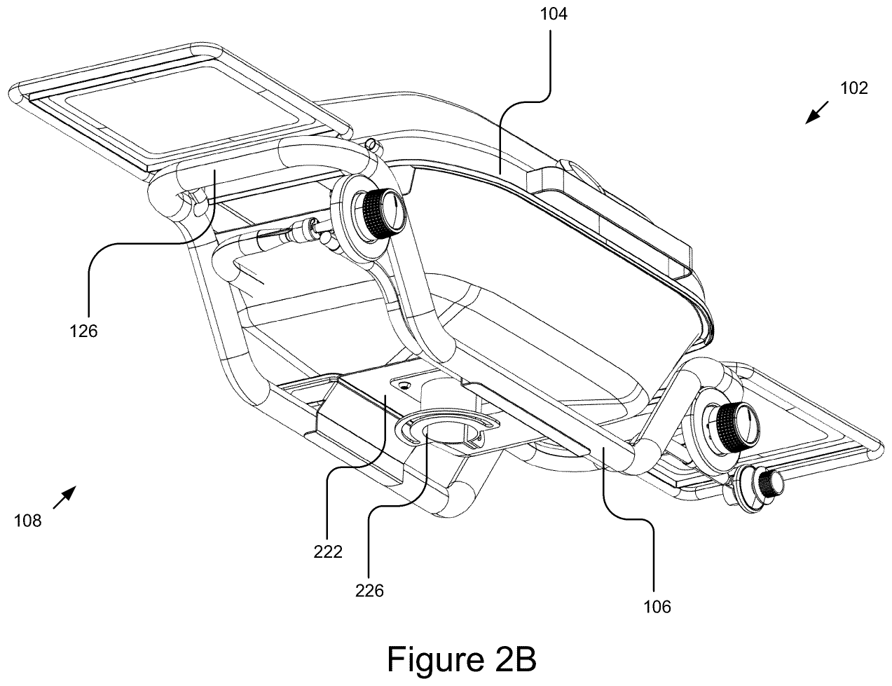

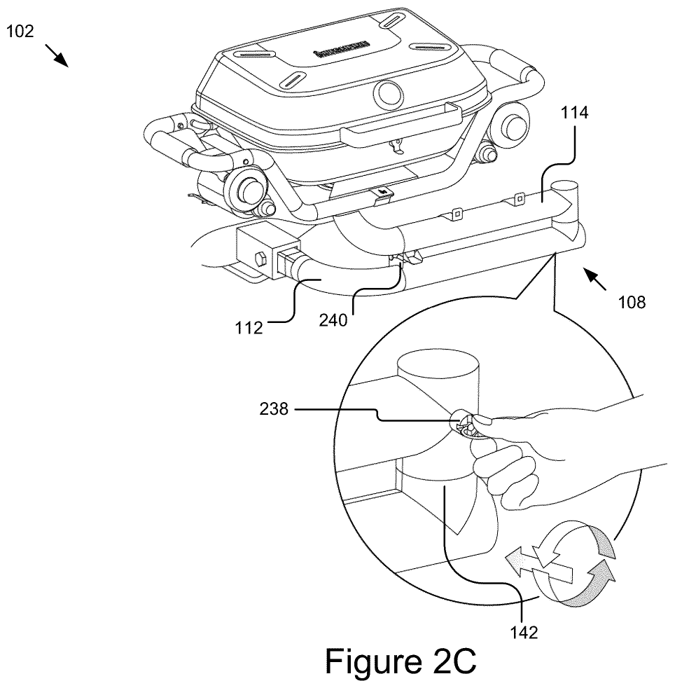

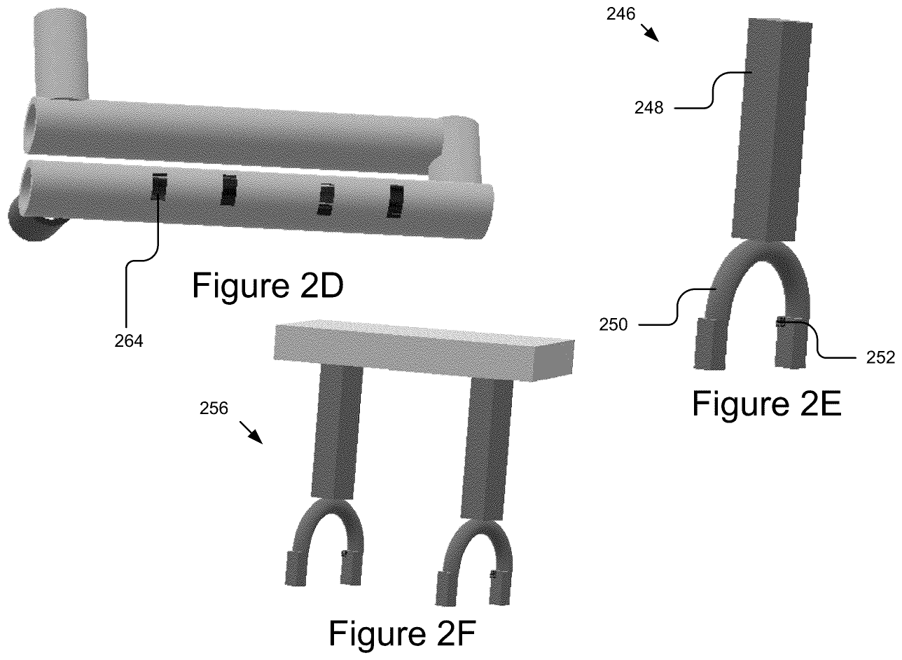

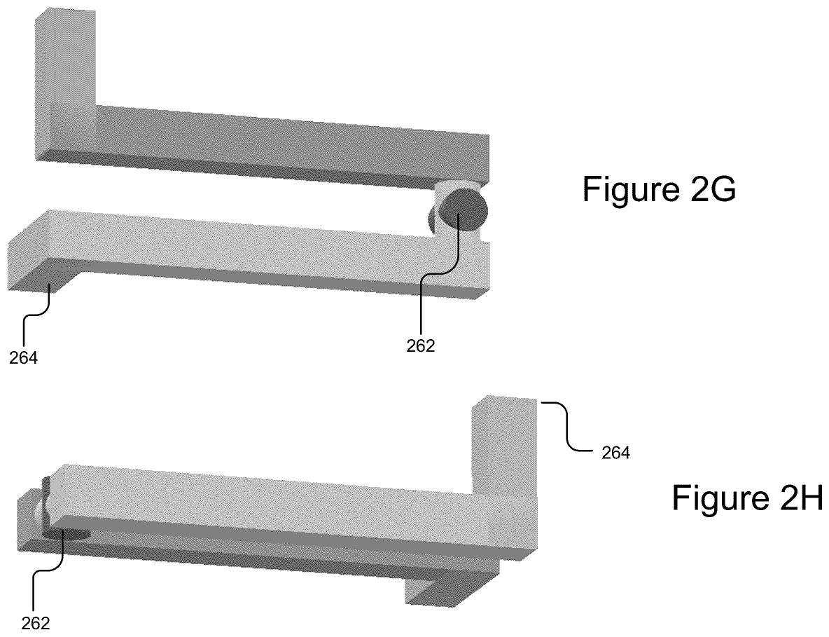

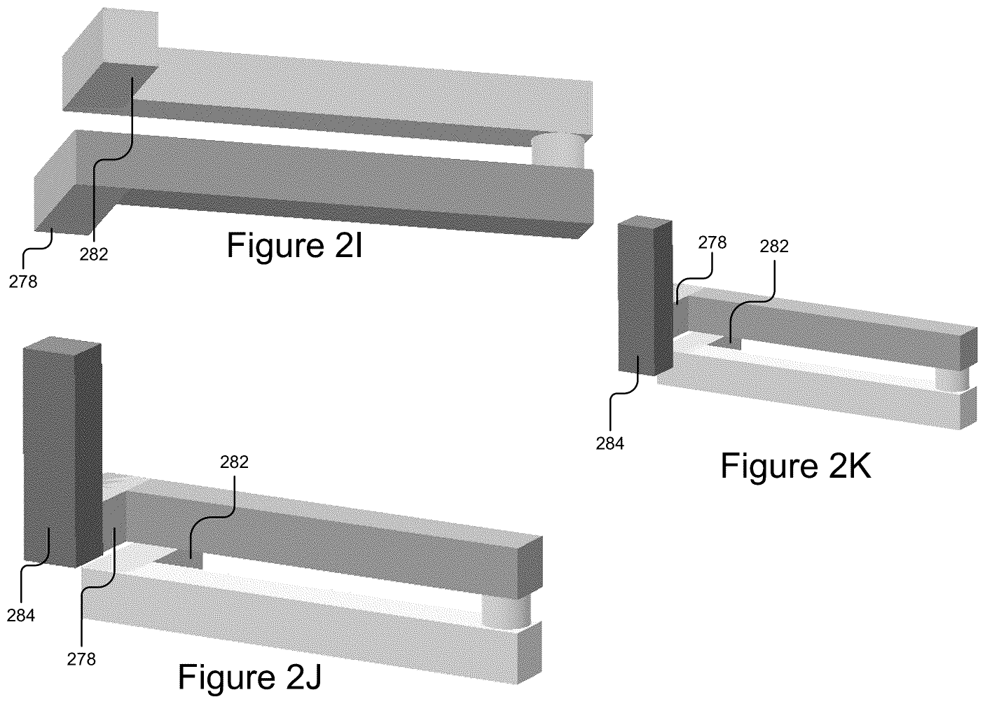

FIG. 2A illustrates an example implementation of a grill system 102 decoupled from a swing arm 114 and vehicle. The figure illustrates a grill body 104, preparation tables 110a and 110b, chassis 106/frame, burner knobs 210a and 210b, and other components. For example, as illustrated, the chassis 106 including a frame attached to and supporting the grill body 104, the chassis 106 including one or more handles 126 integrated with the frame and located at one or more sides of the grill body 104. In some implementations, as illustrated in FIG. 2A and as described in further detail below, the preparation tables 110, when opened, may rest on the chassis 106 (e.g., on the carrying handles 126) to provide vertical support and stability to the preparation tables 110.

As illustrated in FIG. 2A, the grill body 104 may be attached to a chassis 106 system 106 that provides support to the grill body 104 and other components and accessories. Example implementations of the chassis system 106 are further illustrated and described elsewhere herein.

FIG. 2B illustrates an example implementation of a grill system 102 from a bottom-up perspective and detached from a swing-arm system 108 and vehicle. In the illustrated example, a chassis system 106 may include an adapter plate 222 coupling the chassis system 106 to a bottom side of the base 122 of the grill body 104, for example, which may hold the frame away from the body of the grill, thereby providing a gap to prevent heat transfer and mounting of accessories, such as a grill cover. The adapter plate 222 may also provide mounting points for an arm collar 226, as described below, a drip tray, fuel transfer pipes, and/or other components.

As illustrated, depending on the implementation, the carrying handles 126 may be integrated into the chassis 106 thereby allowing the strong chassis 106 to lift the grill body 104, preparation tables 110, and/or the swing-arm system 108 from the vehicle or other surface. In some implementations, the chassis 106 or grill body 104 may be detached from the swing-arm system 108 and the carrying handles 126 may be used to lift the grill body 104 and chassis 106 from the swing-arm system 108. For instance, the chassis 106 may have a flat bottom and/or legs that may support the grill system 102 when removed from the swing-arm system 108 and placed on a surface, such as a table. In some implementations of the chassis 106 may provide a gap between the grill base 122 and a surface upon which the chassis 106 is resting to prevent the surface from being burned/melted by the heat of the grill.

It should be noted that although the chassis system 106 is illustrated as being coupled with a grill body 104, in some implementations, the devices and features described herein may couple with different types of grill bodies, griddles, storage container, sinks, or other devices. For instance, the chassis system 106 may hold a storage container and couple with a swing-arm system 108.

The chassis system 106 may mount to a swing-arm system 108 using a tower or other portion of a swing arm 114, as described above. For instance, a tower (e.g., a vertical portion or riser of the swing arm 114, as noted above) may couple with an arm collar 226, which may be attached to the adapter plate 222, and the adapter plate 222 may be attached to one or more of the frame and the grill base 122. The chassis system 106 may also be used to mount other items, for example, the chassis system 106 may be expanded or re-configured to other sizes or shapes of grills and accessories. Example implementations of an arm collar 226 or other grill-mounting members are described in further detail elsewhere herein.

In some implementations, the chassis system 106 may include a gas canister connector or holder 328 that attaches a gas (e.g., propane, etc.) canister or tank to the chassis system 106. The gas canister holder 328 may allow the gas canister to remain coupled with the grill system 102 during transport or to be easily coupled once stationary.

FIG. 2C illustrates an example grill system 102 and swing-arm system 108 with one or more example pivot locks 238. The hitch arm may pivotably couple with the swing arm 114 via the pivot mechanism, which may be a hinge that allows the swingarm to rotate between a closed position and an open position. The pivot mechanism may be continuously variable through a range of movement, so that the grill system may be stored next to a vehicle or may open for access to a trunk, hatch, or tailgate of the vehicle. In some instances, the pivot mechanism may have a defined range that prevents the grill from hitting the vehicle.

The swing-arm system 108 may include a swing arm 114 release and/or pivot lock 238 for locking the swing arm 114 in one or more orientations. For instance, the pivot or swivel lock 238 may include a pull pin, slider, friction collar or clutch, ratcheting mechanism, etc., for locking the swing arm 114 in one or more angles to the hitch arm 112. For instance, the pivot lock 238 may lock the swing arm 114 to be parallel to the hitch arm 112 and/or rear of the vehicle. The pivot lock 238 may have a continuous/infinitely variable range of locking angles and, in some implementations, may have one or more hard stops. For instance, the pivot lock 238 may stop the swing arm 114 parallel to the hitch arm 112, perpendicular to the hitch arm 112, etc.

For instance, the pivot lock 238 may include a pin, as illustrated in FIG. 2C, that may be pulled out, the swing arm 114 may be rotated, and the pin may be replaced to lock the swing arm 114 in position. The pin may be replaced with a screw knob, or a slidable or swingable tab, which stops rotation and/or increases friction. For instance, a thumb screw may be tightened to engage higher friction on a clutch or friction collar.

In some implementations, the swing-arm system 108 may also include a swing arm release 240 that couples the swing arm 114 with the hitch arm 112 to prevent unintended rotation of the pivot mechanism 142, for example, during movement of the vehicle. For instance, the swing arm release 240 may be a lever, pin, or other lock/catch mechanism that locks the swing arm 114 in place. The swing arm 114 release may be configured to be openable simply and without using a tool. For instance, the swing arm 114 release may include a button or latch, although other implementations (e.g., pin, lock, padlock, etc.) are possible. In some implementations, the swing arm 114 release may also include a stop or back plate that prevents the swing arm from ever rotating past the hitch arm 112, which might allow the swing arm 114 or grill system 102 to contact the vehicle.

For example, FIG. 2D illustrates an example swing-arm system 108 with notches 242 formed in the hitch arm that assist in the attachment of additional towers and/or other accessories. It should be noted that although notches or indentations are illustrated in FIG. 2D, other configurations, such as protrusion, hooks, loops, latches, buckles, etc., are possible and contemplated herein.

FIG. 2E illustrates an example accessory coupler 246 that may be configured to couple one or more accessories at the top of, on the side of, or at another point of a tower portion 248. The accessory coupler 246 may couple with one or more of the swingarm and the hitch arm using a coupling portion 250.

The coupling portion 250 may be shaped to match with a profile of the hitch arm, for example. In some instances, the coupling portion 250 may have protrusions 252, latches, rings, hooks, recesses, etc., that may interact with the notches of the hitch arm 114 to stabilize the accessory coupler 246. In some implementations, the coupling portion 250 may include a bar, buckle, belt, clamp, or other mechanism (not shown) that may be hinged or attached to the coupling portion to wrap under and couple to a hitch arm 112 or swingarm 118. For example, the coupling portion 250 may include a ratcheting strap (e.g., as used in a ski boot), a hinged bar (e.g., forming a clamp over the hitch arm 112 or swing arm 114), or other device extending between the ends of the coupling portion and under the hitch arm or swing arm 114 so that it may apply force to the bottom, top, or sides of the hitch arm 112 or swing arm 114. In some instances, the ends of the coupling portion 250 may be tightened, such as using a tightenable screw/handle, to tighten (e.g., pull together) the ends to clamp or pinch down on the sides and/or bottom of the hitch arm 112 or swing arm 114.

In some implementations, the accessory coupler 246 may be used with various accessories, as described in further detail elsewhere herein, such as the accessory table 132 illustrated in FIG. 1D. In some implementations multiple accessory couplers 246 may be used together to mount an accessory, such as the table 256 illustrated in FIG. 2F, which may be mounted to a hitch arm to provide a working or seating (e.g., a seat may be similarly configured) surface when the swing arm 114 and grill system are pivoted away from the hitch arm 112. Other implementations for accessories and coupling mechanisms that may attach to the swing-arm system 108 are described and illustrated herein.

In some implementations, the technology may allow the orientation of the swing arm system 108 to be switched from right-handed to left-handed orientation, for example, so the hitch arm 112/swing arm 114 may extend either to the right or to the left from a hitch receiver, so that it may be opened to either side of a vehicle to which it may be mounted.

In some implementations, the swing-arm system 108 may include various components for rotating the grill system between orientations (e.g., by rotating the grill body/chassis and pivot mechanism to the other side of the vehicle), as described throughout this description.

In some implementations, the tower may be insertable into the hitch receiver and the portion of the hitch arm 112 that otherwise entered the hitch receiver may extend upward to act as a tower to support the chassis, for example, FIGS. 2G and 2H illustrate an example implementation of a swing-arm system 108, which show that a swing arm 114 and hitch arm 112 may interchangeably couple with either the hitch receiver or tower and/or grill system. For example, in some implementations, the swing-arm system 108 may include an additional hinge(s) 262 or rotation mechanism(s) for rotating one or more of the hitch arm 112 and swing arm 114 to allow the orientation of the swing-arm system 108 to be changed. For instance, the swing arm 114 may rotate 90 degrees (e.g., along its length), the hitch arm 112 may rotate 90 degrees (e.g., along its length), the tower 264 may be inserted into the hitch receiver, and the hitch arm 112 may be coupled with the grill chassis 106 (i.e., instead of the tower 264 attaching to the chassis 106).

As illustrated in FIGS. 2G and 2H, in some implementations, the pivot mechanism or hinge coupling the swingarm and the hitch arm may include an additional pivot point 262 allowing the pivot mechanism to pivot the hitch arm 112 an axis offset at 90 degrees to the ordinary axis of rotation of the pivot mechanism. For instance, as illustrated in FIG. 2G, the hitch arm 112 may couple at 264 with a hitch receiver of a vehicle and the swing arm 114 may swing outward from the vehicle (e.g., the additional pivot point 262 may remain locked and the pivot mechanism may function as described elsewhere herein).

The hitch arm of FIG. 2G may be used as a swing arm and the swing arm of FIG. 2G may be used as a hitch arm, as illustrated in FIG. 2H, so that the point 264 extends upward (or outward, etc., as described in reference to FIG. 2I) to interact with the tower or another mechanism. In such instances, the swingarm may couple with the hitch receiver of a vehicle and the secondary pivot point 262 may be unlocked (e.g., while the other pivot mechanism described above is locked) to allow the grill system (e.g., coupled at 264) to pivot outward from the vehicle, as described elsewhere herein. It should be noted that although the secondary pivot point 262 is illustrated as being a component of the pivot mechanism, it may be integrated with a hitch arm or swing arm or other portion of the swingarm system.

In some implementations, as illustrated in FIGS. 2I, 2J, and 2K, an example implementation of a hitch-arm system 108 is illustrated in which a swing arm 112 may have a protrusion 282 matching a protrusion 278 of a hitch arm 114, and, in some instances, the protrusions 278 and 282 may each be interchangeably coupled with either a tower 284 or a hitch receiver of a vehicle, thereby allowing the swing-arm system 108 to be mounted so that it extends either to the left or to the right from a hitch receiver. For example, the protrusions 278 and 282 may be configured the same or substantially the same to be interchangeable. Further, this configuration facilitates vertical adjustability of the tower 284, as described in further detail below.

In some implementations, the tower 284 may extend upward from (e.g., connected to or integrated with the swing arm 112) to support a chassis 106 of a grill system 102. In some implementations, the tower 284 may couple with the chassis 106 using a friction collar or other rotatable mechanism for allowing the chassis/grill body to pivot on the tower. As described below, the friction collar or other mechanism may open or stop rotation of the grill system by tightening or loosening the friction collar, inserting a pin into a hole to serve as a stop, etc. In some implementations, the chassis 106 or tower 284 may include a rotational release lever, as described elsewhere herein, that stops the grill system at a particular angle or releases its rotation, for example, by engaging a mechanical stop or increasing friction. In some implementations, the coupling between the chassis and the tower may use both a friction and hard stop, so the grill system may rotate infinitely within a defined range of angles (e.g., to prevent the grill system from striking the vehicle).

In some implementations, the tower 284 and chassis 106 may be configured to decouple from one another, for instance by releasing a rotational release lever, loosening a screw on a friction collar, removing a quick-release pin inserted through the chassis into a component of the tower, etc. Accordingly, the chassis 106 and grill body may be lifted from the tower 284 using handles on the chassis. The tower 284 may then couple with other accessories, such as umbrellas, cutting boards, handwashing stations, etc., using the same or similar mechanism as the grill system 102.

In some implementations, the tower 284 may be extendable or movable along a protrusion (e.g., as in FIG. 2K) to allow a grill or other attached device to be lifted or lowered to accommodate different vehicle heights. For instance, the tower 284 may include a slidable, lockable sleeve (e.g., using friction or pin, etc., as described elsewhere herein) or additional bar that allows the tower 284 to be shortened or extended.

In some implementations, the tower 284 may be coupled to a swing arm 112 that faces outward from the vehicle, for example, as illustrated in the implementation of FIGS. 2I, 2J, and 2K, which show a swing arm 112 with a protrusion 282 extending outward and coupling with a tower 284. In some instances, the protrusion 278 may enter one or more corresponding receiving recesses in the tower 284, so that the tower 284 may be attached to the protrusion 282/swingarm at different heights or in different directions (e.g., up or down). For example, FIG. 2K shows the tower 284 mounted at a different height with the protrusion 282 than FIG. 2J. In some implementations, as noted above, the tower 284 could mount to either protrusion 278 or 282.

In some implementations, the protrusion 278 may include a holder, such as a collar or pass through that holds the tower 284. The holder may include a locking mechanism where a pin, screw, or other mechanism may be inserted through a pass-through, hole, etc., of the tower 284 to lock the tower 284 at a given height and/or rotation with the protrusion 278 or 282. For example, the protrusion 278 may include a friction collar (e.g., as described elsewhere herein) and the tower 284 may pass through the friction collar, which may be used to set a height and/or rotation of the tower 284.

In some implementations, the protrusion 282 and/or swing arm may pivot or rotate about one or more axes, for instance, to level or make the tower 284 and/or grill system 102 plumb.

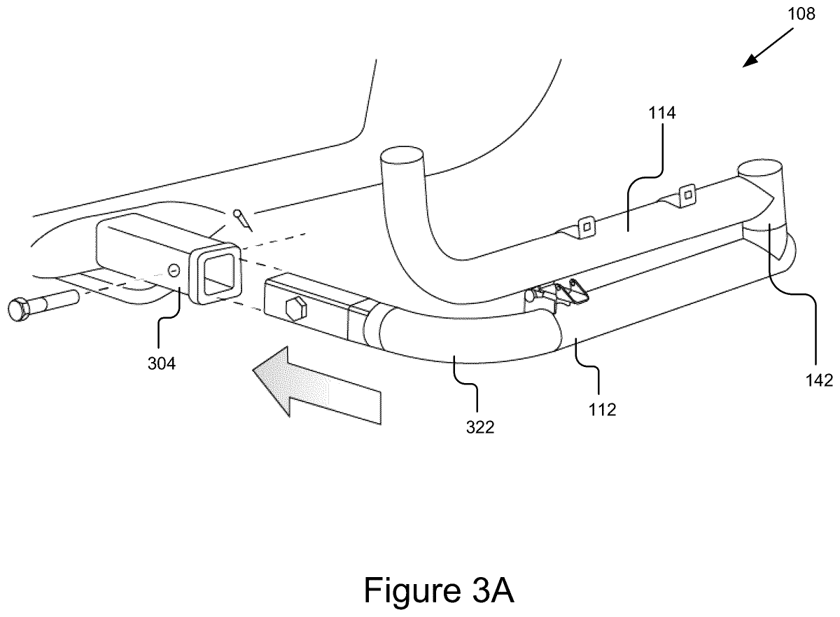

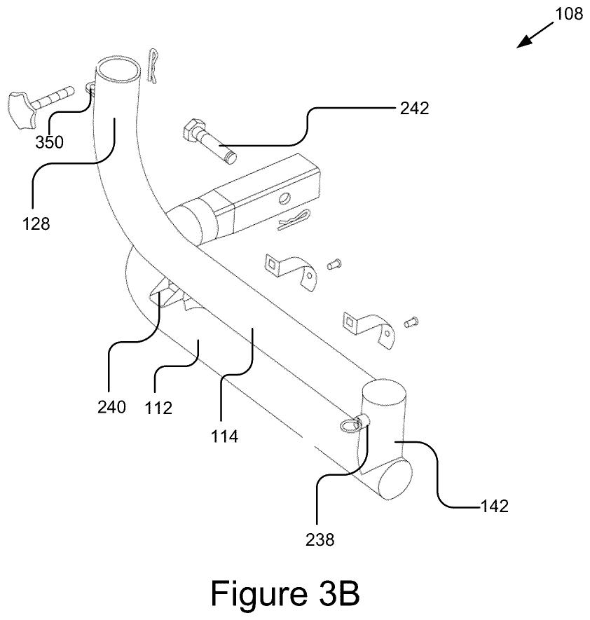

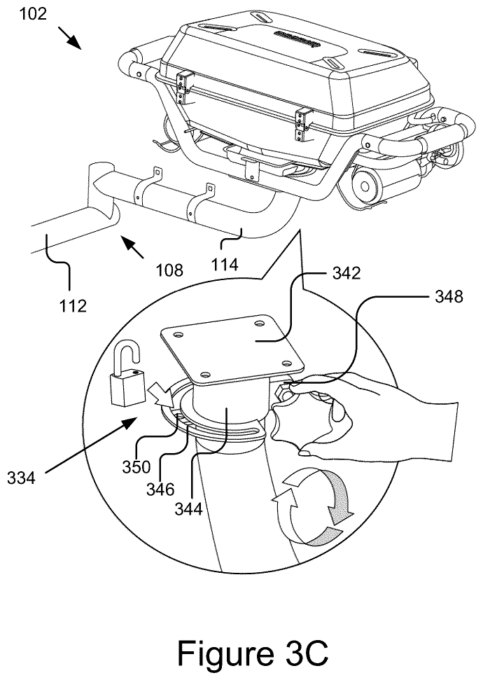

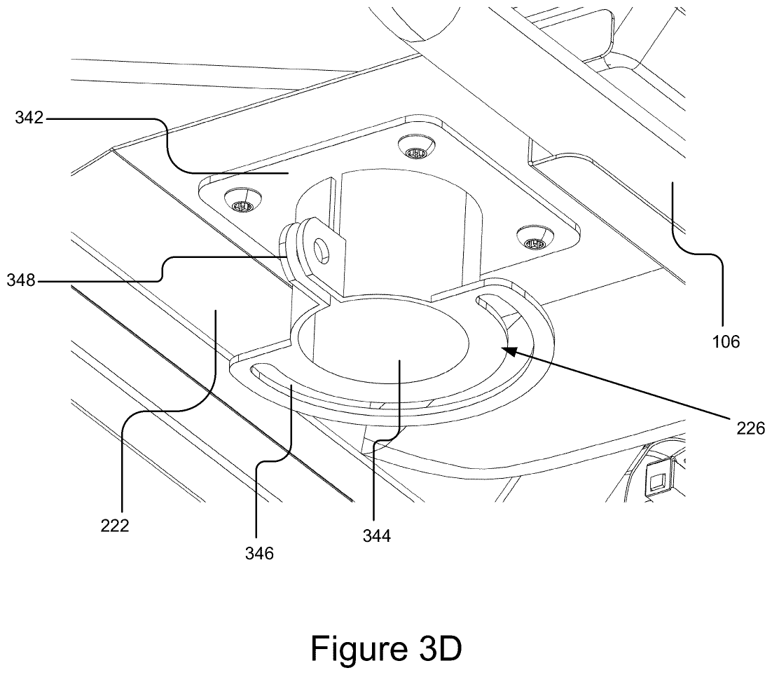

FIG. 3A illustrates an example swing-arm system 108 and vehicle hitch-receiver 304 according to some implementations. FIG. 3B illustrates an example swing-arm system 108 decoupled from a grill body 104 and from a vehicle. As illustrated, the swing-arm system 108 may include a hitch arm 112, swing arm 114, pivot mechanism 142, pivot lock 238, swing arm 114 release 240, receiver lock 242, tower or vertical portion 128, and/or other components.

The hitch arm 112 may pivotably couple with the swing arm 114 via the pivot mechanism 142, which may be a hinge that allows the swing arm 114 to rotate between a closed position shown in FIG. 1B and an open position shown in FIG. 1A. The pivot mechanism 142 may be continuously variable through a range of movement, so that the grill system 102 may be stored next to a vehicle or may open for access to a trunk, hatch, or tailgate of the vehicle. In some instances, the pivot mechanism 142 may have a defined range that prevents the grill from hitting the vehicle.

In some implementations, the hitch arm 112 may couple with a hitch receiver 304 using a receiver lock 242, which may include a mechanism for locking and/or tightening the connection between the hitch receiver 304 and the hitch arm 112. For instance, the receiver lock 242 may include a stabilizer bolt and cotter pin.

In some implementations, the receiver lock 242 may include a mechanism for tightening the connection between the hitch receiver 304 and the hitch arm 112. For instance, the receiver lock 242 may include a knob and screw mechanism that may be tightened to expand a total width or height of the portion of the swing arm 114 inserted into the hitch receiver 304 thereby making the fit tighter and reducing movement of the hitch arm 112 and grill system 102. For instance, the receiver lock 242 may expand a wedge or insert a metal or plastic shim to reduce the space between the hitch receiver 304 and the portion of the hitch arm 112 inserted into it.

In some implementations, the hitch arm 112 may have a pass through (not illustrated), additional hitch receiver 304, additional hitch arm 112, etc., for coupling a hitch ball for a trailer, a second grill system 102 using a second swing-arm system 108, or other accessories. For example, the hitch arm 112, or an adapter mechanism, may include multiple hitch receivers 304 for adding accessories, for example, using a similar swing-arm system 108 as described herein. For instance, the additional hitch receivers 304 or hitch arms 112 may mount an umbrella, cutting board, second grill system 102, or other accessories.

In some implementations, the swing-arm system 108 may allow the orientation of the swing-arm system 108 to be switched from right-handed to left-handed orientation, for example, so the hitch arm 112/swing arm 114 may extend either to the right or to the left from the hitch receiver 304. Various implementations of switching the swing-arm system 108 between orientations or configurations are described elsewhere in this description.

In some implementations, the swing-arm system 108 may include a hinge at the elbow 322 for rotating the grill system 102 between orientations (e.g., by rotating the grill body 104/chassis 106 and pivot mechanism 142 to the other side of the vehicle). Other implementations for a reversible swing arm system 108 are described herein.

In some instances, the swing-arm system 108 may include a license plate bracket for mounting a license plate.

In some implementations, the swing-arm system 108 may include accessory mounting points, which may include recesses, protrusions, or other structures for receiving accessories. For instance, a top surface of a hitch arm 112 or swing arm 114 may include holes into which an accessory mounting bracket, table legs, or other devices may be inserted thereby mounting additional accessories. Other accessory mounting points may include threaded bolt holes located along one or both horizontal sides of the hitch arm 112 or swing arm 114, so that an accessory mounting bracket may be coupled therewith leading to a configuration, such as is illustrated in FIG. 1D.

FIGS. 3C and 3D illustrate an example grill mounting member 334, such as an arm collar 226 for coupling the swing arm 114 with the with the chassis 106 and/or grill body 104. For example, a gill-mounting member 334 may be a tower, portion of a tower, and/or device coupled with or couplable with the swing arm 114 that allows the grill body 104 to be attached thereto. For instance, the grill-mounting member 334 may include an arm collar 226 couplable to one or more of the swing arm 114, a chassis 106, and a grill body 104.

In some implementations, the tower or swing arm 114 may extend upward to support the chassis 106 of the grill system 102. In some implementations, the tower may couple with the chassis 106 using a friction collar or other rotatable mechanism for allowing the chassis 106/grill body 104 to pivot on the tower.

In some implementations, the arm collar 226 may include a mounting plate 342 including a flat top surface that is adapted to couple to one or more of the chassis 106 (e.g., via an adapter plate 222) and the grill body 104. For instance, the mounting plate 342 may include fasteners, fastener receivers, or other structures for attaching various devices, such as a grill body 104, chassis system 106, kitchen, storage container, platform, or another object to the arm collar 226.

In some implementations, the arm collar 226 may include a friction collar 344 coupled with the mounting plate 342 and adapted to provide rotational friction between the friction collar 344 and the tower of the swing arm 114. The friction collar or other mechanism may open or stop rotation of the grill system 102 by tightening or loosening the friction collar 344, inserting a pin into a hole to serve as a stop, etc. For instance, the chassis 106 or tower may include a rotational release lever that stops the grill system 102 at a particular angle or releases its rotation, for example, by engaging a mechanical stop or increasing friction. In some implementations, the coupling between the chassis 106 and the tower may use both a friction and hard stop, so the grill system 102 may rotate infinitely within a defined range of angles (e.g., to prevent the grill system 102 from striking the vehicle).

The friction collar 344 may include a collar (e.g., with a gap around its circumference allowing it to be tightened) or sleeve into which a portion of the tower of the swing-arm system 108 may be inserted. The friction collar 344 may include a screw hole and bolt 348 that tightens the collar/sleeve to prevent rotation, decrease rattling, and potentially lock the grill system 102 to the swing-arm system 108. In some implementations, the tower may include a ring that slides into the collar 344, so that when the collar is sufficiently tight, the grill system 102 cannot be removed from the swing-arm system 108 because the ring is larger than the tightened collar.

In some implementations, the arm collar 226 may include a channel 346 extending circumferentially around the arm collar 226, the channel 346 adapted to couple with the swing arm 114 while the arm collar 226 rotates around an axis formed by the tower of the swing arm 114. It should be noted that in an alternative implementation, the channel 346 may be located on the swing arm 114 instead of the arm collar 226. For instance, arm collar 226 may include an arc-shaped channel 346 through which a component of the tower (e.g., a protrusion), for example, may slide, thereby defining a range of rotation of the grill system 102 while the grill system 102 is attached to the swing-arm system 108. In some instances, the tower may include a tightenable screw, padlock, clamp, spring-loaded pin, or other device for locking the grill system 102 to a given orientation. In some implementations, the arc-shaped channel 346 may include or be replaced by bumps, gears, etc., to provide rotation stops.

In some implementations, the swing arm 114 (e.g., a tower thereof) may include a tab 350 coupled thereto, which may include aperture that aligns with a portion of the channel 346 when the arm collar 226 is coupled to the tower, the aperture allowing a locking member (e.g., a bolt, padlock, or other fastener) to pass through the aperture and the channel 346 to lock the arm collar 226 to the swing arm 114 (e.g., to a vertical portion 128 or tower).

In some implementations, the arm collar 226 may include a height adjustment mechanism where a pin, screw, or other mechanism may be inserted through a pass-through, hole, etc., of the tower to lock the tower at a given height and/or rotation respective to the protrusion. For example, the protrusion may include a friction collar (e.g., as described elsewhere herein) and the tower may pass through the friction collar, which may be used to set a height and/or rotation of the tower.

In some implementations, the swing arm 114 and chassis 106 may be configured to decouple from one another, for instance, by releasing a rotational release lever, loosening a screw on a friction collar, removing a quick-release pin inserted through the chassis 106 into a component of the swing arm 114, etc. Accordingly, the chassis 106 and grill body 104 may be lifted from the tower using handles 126 on the chassis 106. The tower may then couple with other accessories, such as umbrellas, cutting boards, storage boxes, handwashing stations, etc., using the same or similar mechanism as the grill system 102.

In some implementations, the grill-mounting member may include a rotational release lever in the adapter plate 222, frame, handle, etc., for engaging or releasing a mechanism that allows/disallows rotation of the grill system 102 and/or allows the grill system 102 to be decoupled and lifted from the swing-arm system 108. For instance, the rotational release lever may include a button or lever that pulls a pin (e.g., from a hole or channel) that locks the rotation or locks the base system to the tower.

In some implementations, the tower may be extendable to allow the grill system 102 to be lifted or lowered to accommodate different vehicle heights. For instance, the tower may include a slidable, lockable sleeve (e.g., using friction or pin, etc., as described elsewhere herein) or additional bar that allows the tower to be shortened or extended.

In some implementations, the swing-arm system 108, tower, or chassis 106 may tilt forward/rearward or left/right to allow the grilling surface and/or preparation tables 110 to be leveled in one or more directions. For instance, if a vehicle is parked with a front end of the vehicle at a different height than the rear of the vehicle, food may slide or roll off the grilling service. In some instances, the tower may include pivot points or other mechanisms for leveling the grill surface.

In some implementations, the tower or other portion of the swing arm 114 (e.g., at a grill-mounting member 334, hinge, adapter plate 222, or other component) may include a gimbal mechanism that levels the grill and/or any associated accessories coupled with the gimbal mechanism. The gimbal/leveling device may include various mechanisms for adjusting the levelness of the grill, accessory, tower, swing arm 114, or other component. For instance, the gimbal may couple the grill and/or grill chassis 106 to the tower and level the grill. Depending on the implementation, the gimbal may include a ball and socket with a tightening screw and/or locking pin in the socket (e.g., in place of, in addition to, or similar to the friction collar described elsewhere herein), or it may include another pivoting suspension device.

In some implementations, the swing-arm system 108, such as on the hitch arm 112, swing arm 114, tower, etc., may include mounting points for adding additional accessories. In some implementations, the mounting points may include a vertical hole at the pivot mechanism 142 or notches along the length of the swing arm 114 or hitch arm 112, so that a collar or fork-like structure could be tightened around the hitch or swing arm 114 body, for instance, without allowing the bracket to rotate about the arm. For example, these example implementations allow posts or legs that support a table, cutting board, cooler, or umbrella to be easily and securely mounted to the swing-arm system 108. The accessory mounting points may include structures, such as square impressions, grooves, channels, protrusions, threaded bolt holes, bolts, or other devices on a hitch arm 112 and/or swing arm 114. In some instances, the accessory mounting bracket may include a collar that extends fully or partially around a hitch arm 112 or swing arm 114 or otherwise couples with the accessory mounting point(s), thereby reducing the likelihood that an accessory would rotate about one of the arms or otherwise become loose. An accessory mounting bracket may include contour(s) matching a hitch or swing arm 114, reinforcing member, mounting point(s), and/or extended poles, which may serve as legs (e.g., 134) to an accessory, such as a table or cutting board.

In some implementations, the accessory mounting brackets may be U shaped, flat, or have various other shapes. In some implementations, the accessory mounting brackets may include magnetic or spring-loaded pins, which may interact with (e.g., insert into) the accessory mounting points (e.g., on a hitch arm 112, swing arm 114, or other device) thereby allowing the accessory mounting bracket(s) to be quickly and easily secured. Clamps, straps, hinged bars, ratcheting straps, or other mechanisms may additionally or alternatively be used to couple the bracket or accessory to the swing-arm system 108. Other devices extending between the ends of the coupling portion and under the hitch arm 112 or swing arm 114 may be used to apply force to the bottom, top, or sides of the hitch arm 112 or swing arm 114. In some instances, the ends of the coupling portion may be tightened, such as using a tightenable screw/handle, to tighten (e.g., pull together) the ends to clamp or pinch down on the sides and/or bottom of the hitch or swing arm 114. It should be noted that although bolts, screws, pins, clamps, and other structures are described, other fasteners or fastening mechanism are possible and contemplated herein.

For instance, accessory mounting bracket may include legs or elongated poles for coupling accessories. For example, accessory mounting bracket may be integrated with or have various structures for coupling accessories, such as an umbrella, ice bucket, cooler, mounting plate (e.g., of a grill system 102 or other accessory), chair, table, etc., so that it may modularly add various accessories. In some implementations multiple accessory couplers may be used together to mount an accessory, which may be mounted to a hitch arm 112 to provide a working or seating (e.g., a seat may be similarly configured) surface when the swing arm 114 and grill system 102 are pivoted away from the hitch arm 112.

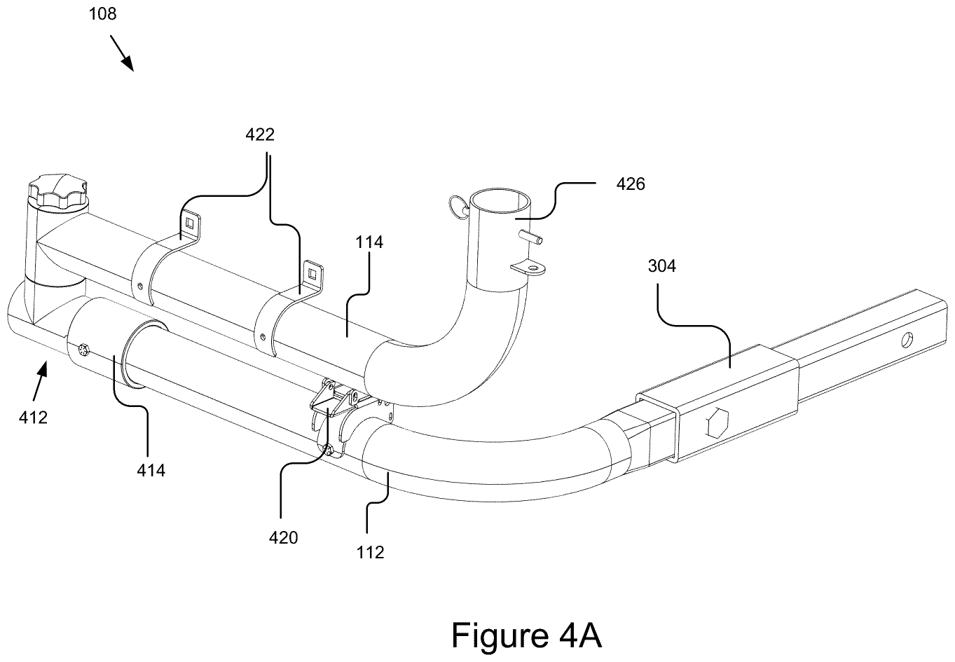

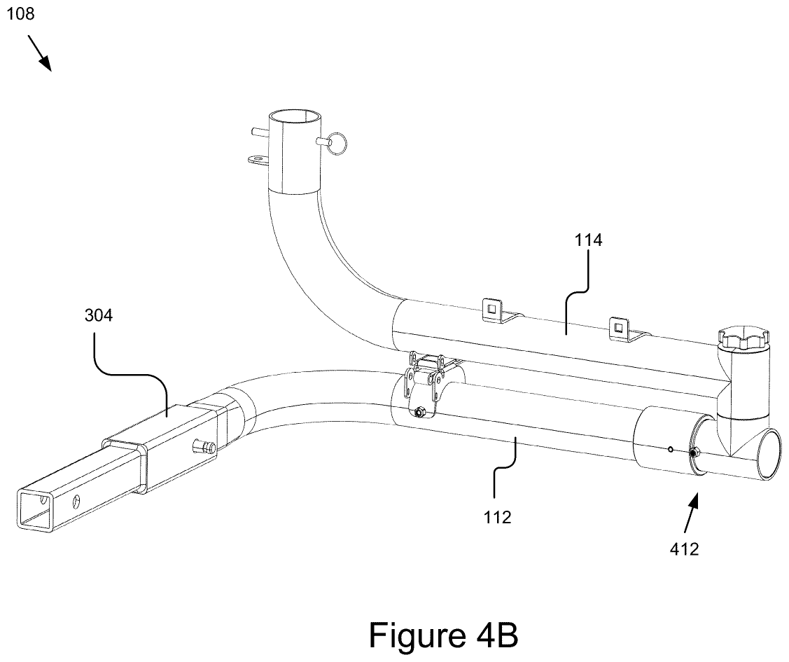

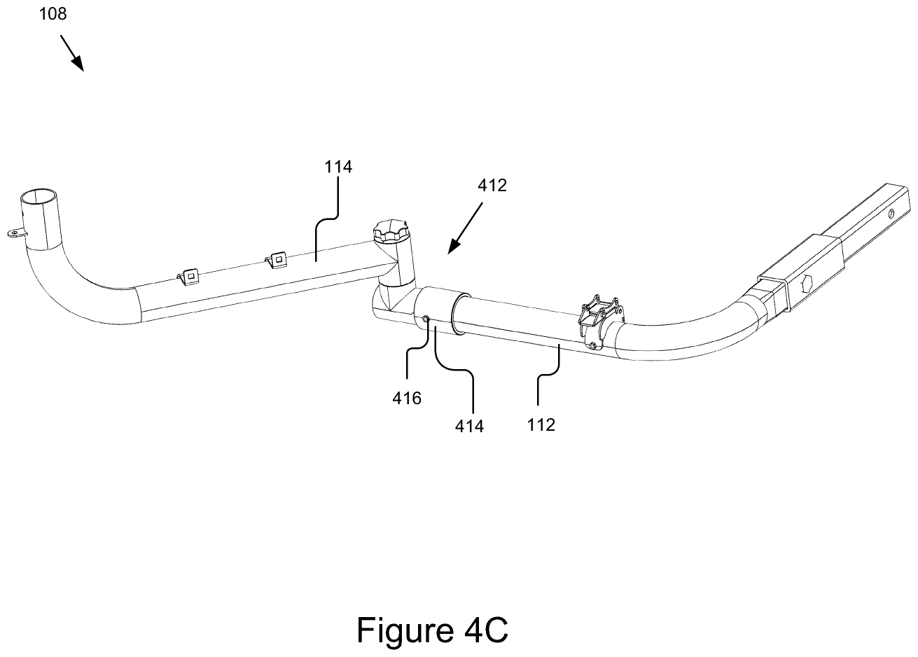

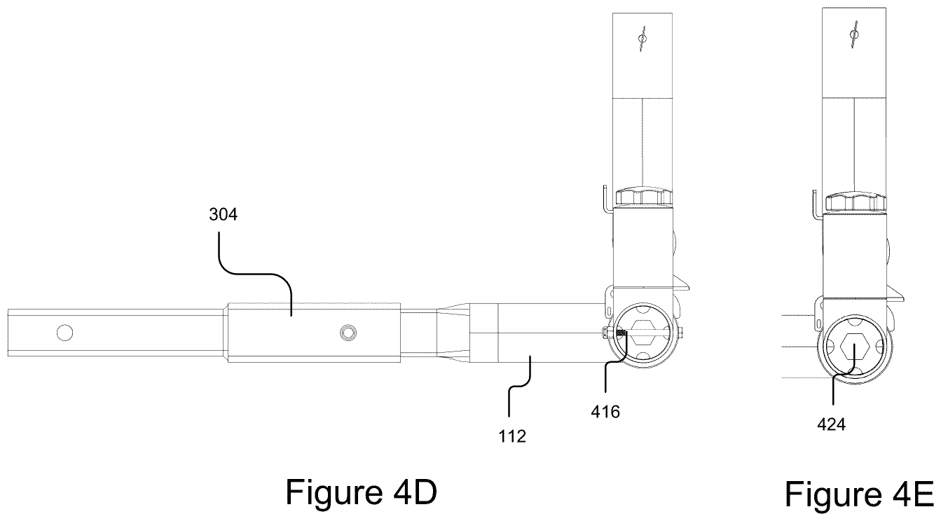

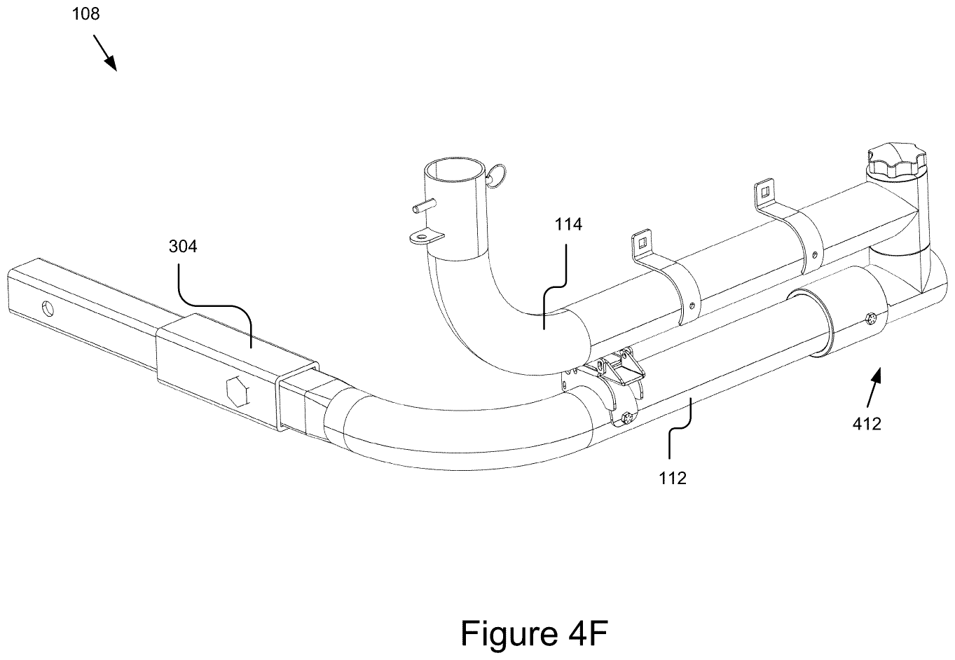

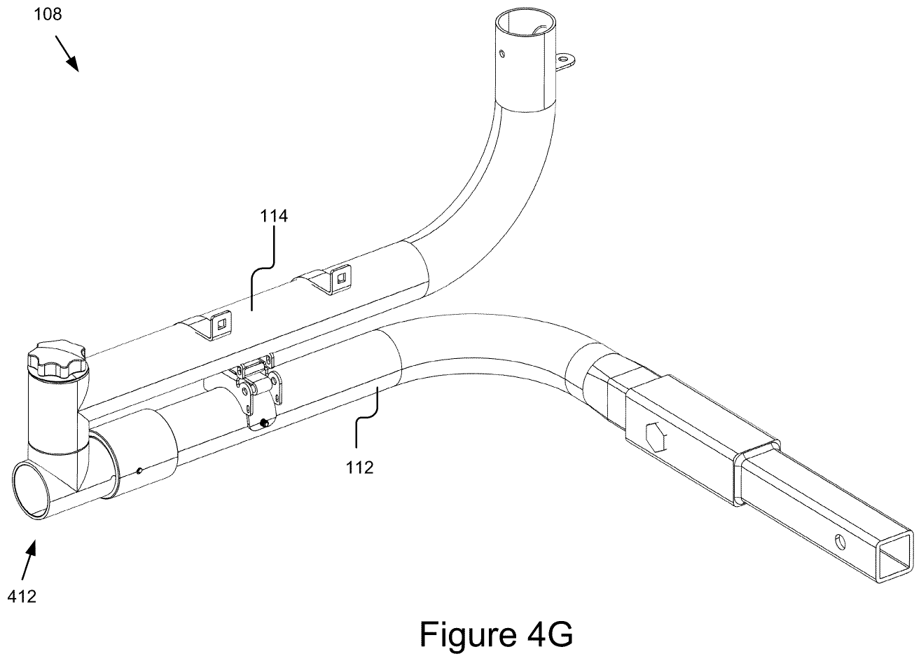

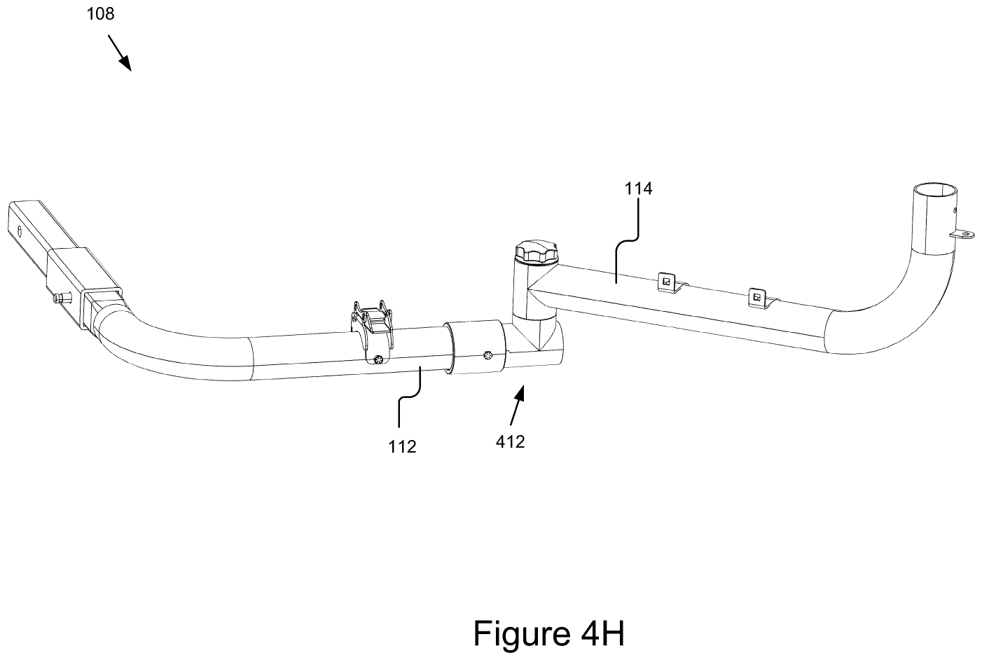

FIG. 4A illustrates an example reversible swingarm system that provides numerous improvements over previous systems. For instance, the reversible swing arm system provides a single system that can be used in either left-handed (e.g., swinging to a left side of a vehicle) or right-handed (e.g., swinging to a right side of a vehicle) configuration. The system allows the use of a single system in a reversible manner while allowing easy switching and manufacturability, while also being strong and stable. Because the swingarm system may include a riser that holds a grill, kitchen, storage, or other items, it is desirable that the riser remain facing upwards, so in order to change orientations of the swingarm system, it is desirable that the riser remain facing upward in both configurations and throughout a swing/pivot range of the swingarm system.

As illustrated in the example, a hitch arm assembly may include a bar or tube curved or bent at a right angle where one end inserts or interacts with (e.g., is inserted into) a hitch receiver 304 of a vehicle. The opposing end of the hitch arm may include a sleeve or other structure that couples with a reversible hinge mechanism, which in turn is integrated into or coupled with a swing arm assembly. The hitch arm assembly may include a swing lock that is mountable on either its top or bottom, a sleeve or other connection mechanism for coupling with the reversible hinge mechanism or other features. The hitch arm is described in further detail below.

The swing arm may swing or pivot about the hinge to allow it to swing away from a vehicle to which the hitch arm is mounted. The swing arm may include various other attachments or features, such as a riser that may couple with a grill, kitchen, storage, or other accessories. The swing arm may include one or more movable clamps that couple various accessories with the swing arm, such as a cutting board or side table, as noted above. These clamps may be removed by loosening a bolt that passes through the swing arm to move them to an opposite side of the swing arm for cases in which it is desirable to mount the accessories to the opposite side, such as when the right/left handedness of the configuration is changed.

Additionally, as noted below, a swing lock may be removed from a hitch arm and placed on the opposite side (e.g., the bottom/top) to switch its position as is described in further detail below.

FIG. 4A illustrates an example reversible swingarm system 108 in a left-handed configuration where the swing-arm system 108 is closed, such as against a vehicle during transport (e.g., seen as if facing toward a vehicle). FIG. 4B shows the example reversible swing-arm system 108 in a left-handed configuration and from another angle (e.g., facing away from a vehicle). FIG. 4C shows the example reversible swing-arm system 108 in a left-handed configuration and in an open position where the swing arm 114 has swung away from the hitch arm 112, for example, to move away from a vehicle, such as where tailgate access is needed. As shown, the swing arm 114 has swung away from the hitch arm 112 by pivoting about the reversible hinge assembly 412. Accordingly, as illustrated, it can be swung open or closed while in the illustrated example (e.g., left-handed) configuration. For example, depending on the implementation, the illustrated hitch receiver 304 may be part of a vehicle and may receive the hitch arm 112 in multiple (e.g., extending to the left or to the right) orientations.

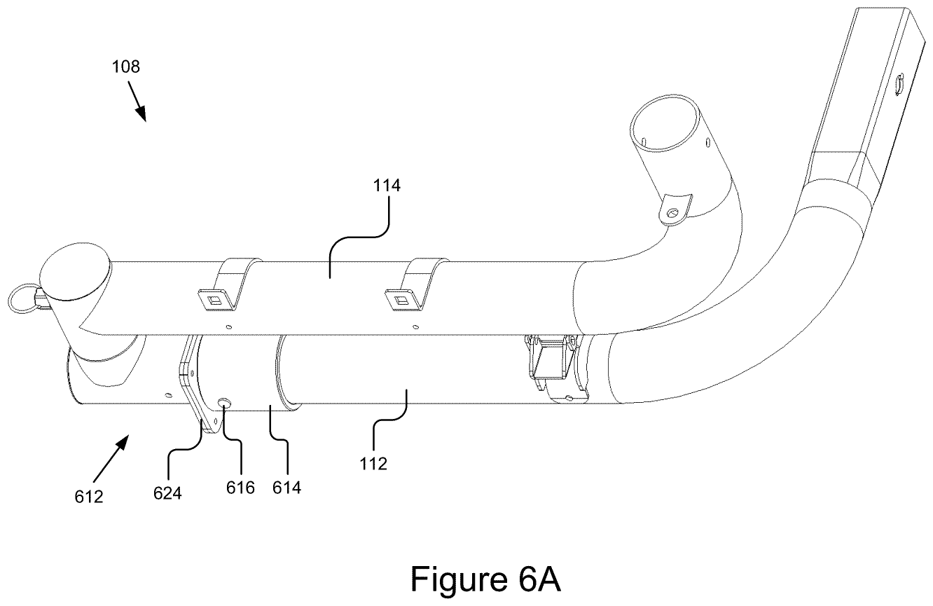

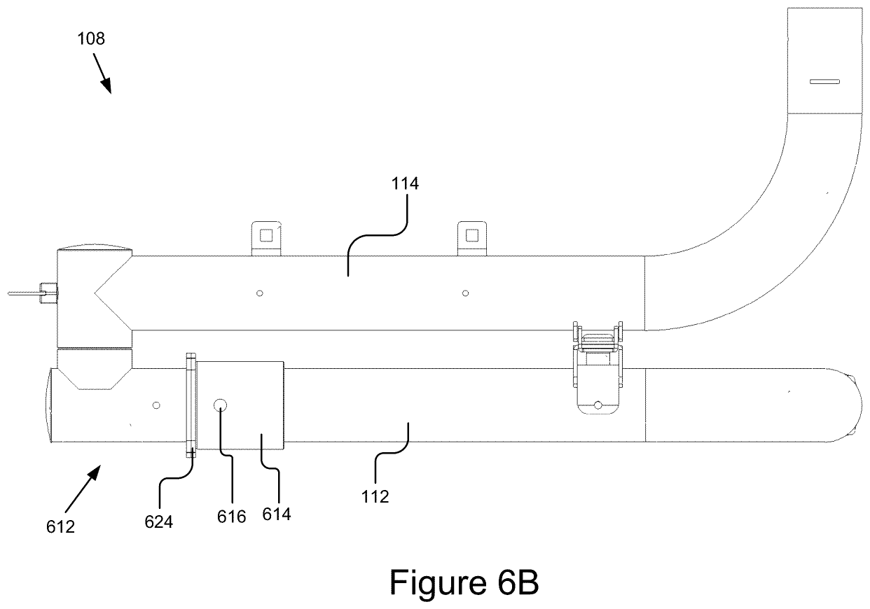

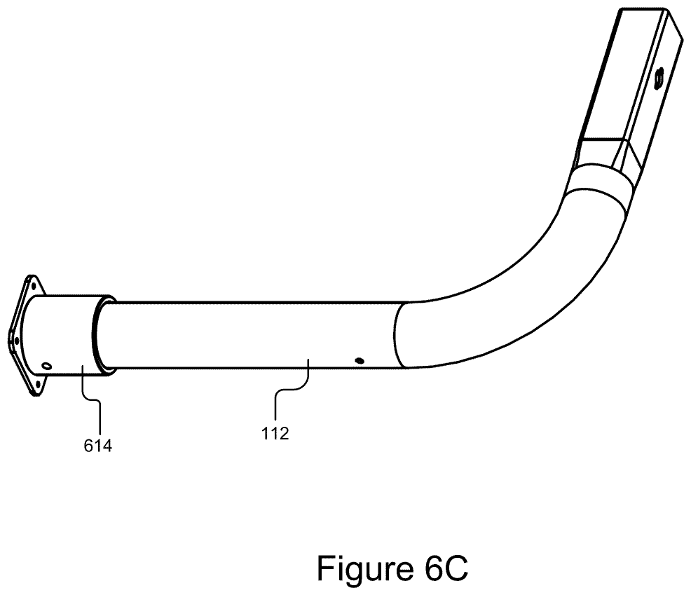

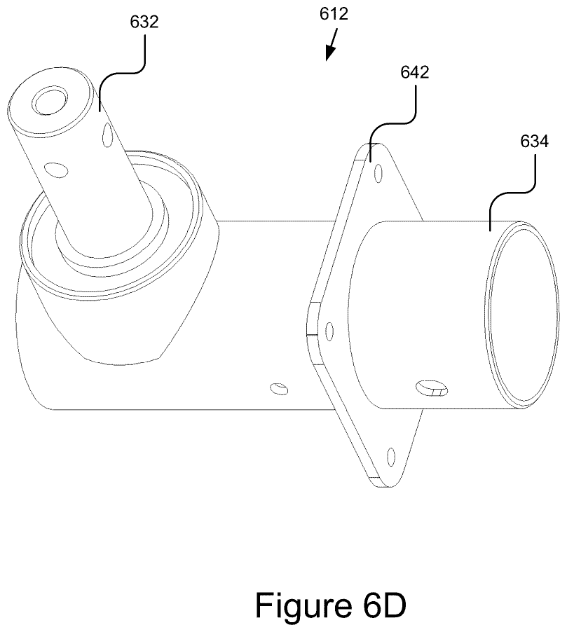

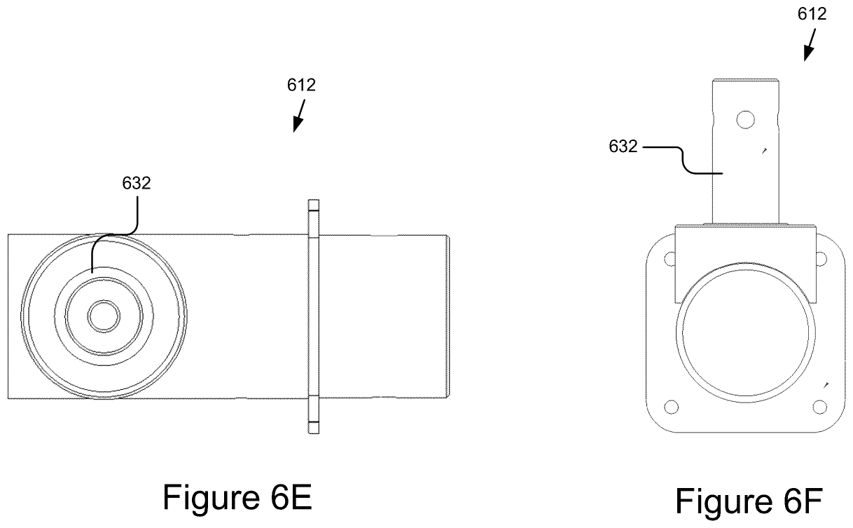

Depending on the implementation, as illustrated in the example of FIGS. 4A-4C, the example reversible hinge mechanism 412 may include and/or insert into a sleeve 414 or into a body of the hitch arm 112 (or swing arm 114, depending on the implementation), which may provide further protection, security, or rigidity to the connection. Other implementations of the reversible hinge mechanism 412 are described elsewhere herein, such as where a coupling plate (e.g., as in the example of FIG. 6A) is used. Additional details of example reversible hinge mechanism 412 are described elsewhere herein.

In some implementations, as described elsewhere herein, the swing-arm system 108 may include or receive one or more accessory clamps 422 for mounting a license plate, accessory table, or other devices. For example, the accessory clamps 422 and/or mounting points (e.g., bolt holes, recesses, protrusions, etc.) of the swing arm 114 may be configured to allow accessories, etc., to be mounted in either direction corresponding to either a left- or a right-handed configuration.

As described in further detail above, the swing arm 114 may extend vertically when the swing-arm system 108 is mounted to a hitch receiver 304 of a vehicle. For instance, a riser 426 of the swing arm 114 may extend upwards to couple with one or more devices, such as a grill, chassis, kitchen, storage container, platform, or other device.

In some implementations, a swing lock 420 may be used to couple the hitch arm 112 and swing arm 114 together, for example, to prevent the swing arm 114 from moving away from the hitch arm 112 during movement of a vehicle, when the vehicle is parked on a hill, and/or to prevent the swing arm 114 from swinging into the vehicle. Additional details of the example swing lock 420 are described elsewhere herein.

Additionally, as shown in FIG. 4C a security bolt 416 is shown passing through the sleeve of the hitch arm 112 and into and/or through a corresponding hole in the reversible hinge mechanism 412. The security bolt 416 may be placed to couple the hitch arm 112 and hinge mechanism in order to couple the two components together and/or provide an additional backup failsafe to the hinge's coupling mechanism 412 as described below.

FIG. 4D illustrates the example reversible swingarm system 108 in a left-handed configuration and viewed from the side, so that an interior of the reversible hinge mechanism 412 is visible. As shown, the security bolt 416 may pass through both the hitch arm 112 (e.g., at a sleeve 414) and through the hinge mechanism 412 (e.g., a portion thereof inserted into the sleeve 414). Accordingly, the security bolt 416 prevents the hinge mechanism 412 from unintentionally decoupling from the hitch arm 112 (or swing arm 114, depending on the implementation).

FIG. 4E illustrates a portion of the example reversible swingarm system in the left-handed configuration and viewed from the same side as FIG. 4D. As illustrated in the example, the security bolt 416 has been removed to expose a coupling mechanism 424 accessible through the end of the reversible hinge mechanism 412, although other implementations are possible. The coupling mechanism 424 may include a bolt that increases friction (or otherwise secures) between the hinge mechanism and the hitch arm 112 or sleeve 414 in order to couple the reversible hinge mechanism 412 with the hitch arm 112, as described in further detail in the examples below.

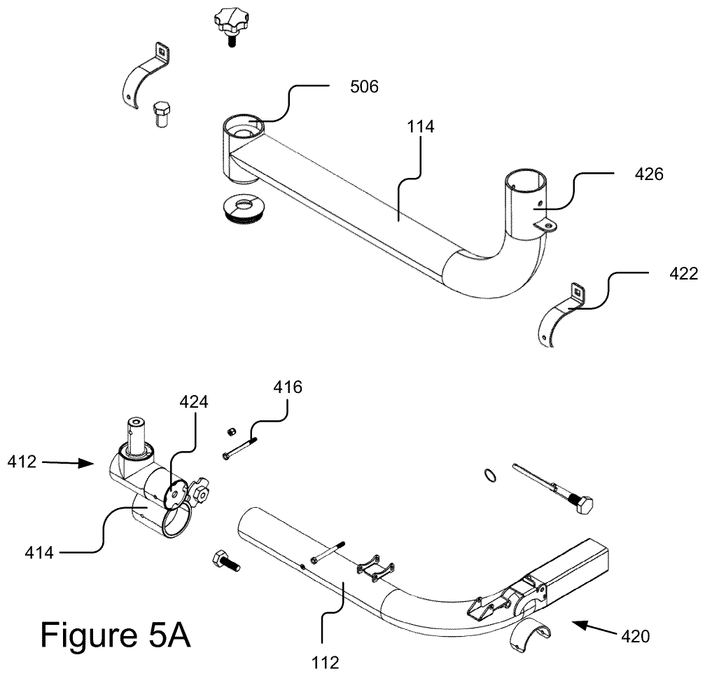

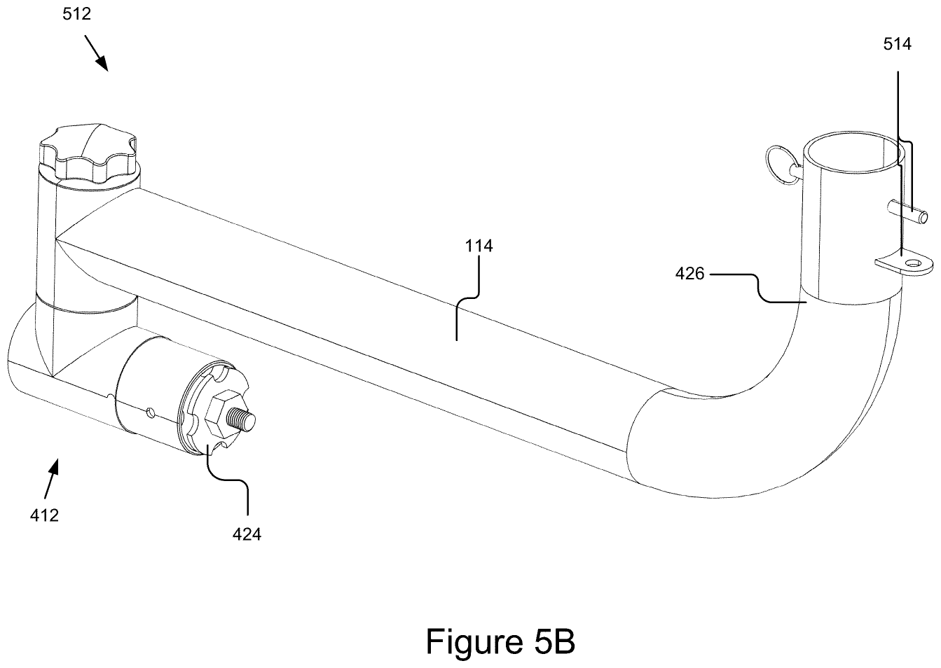

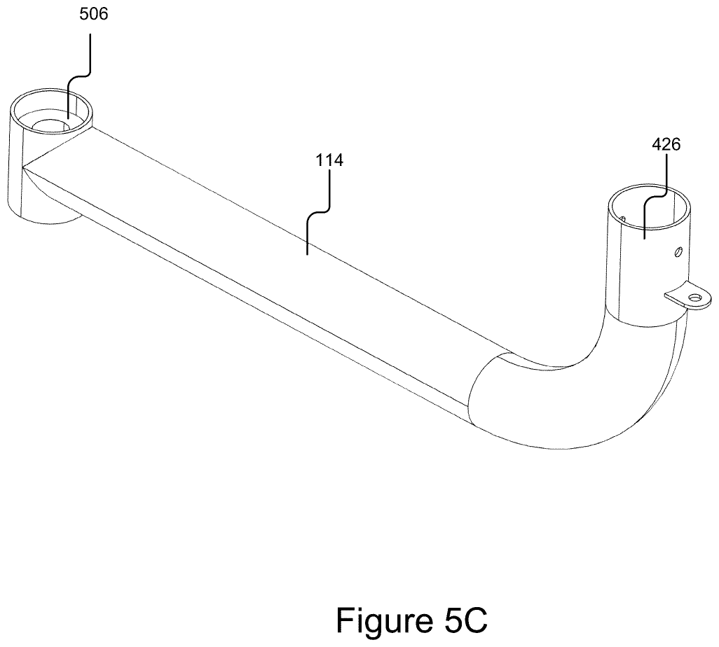

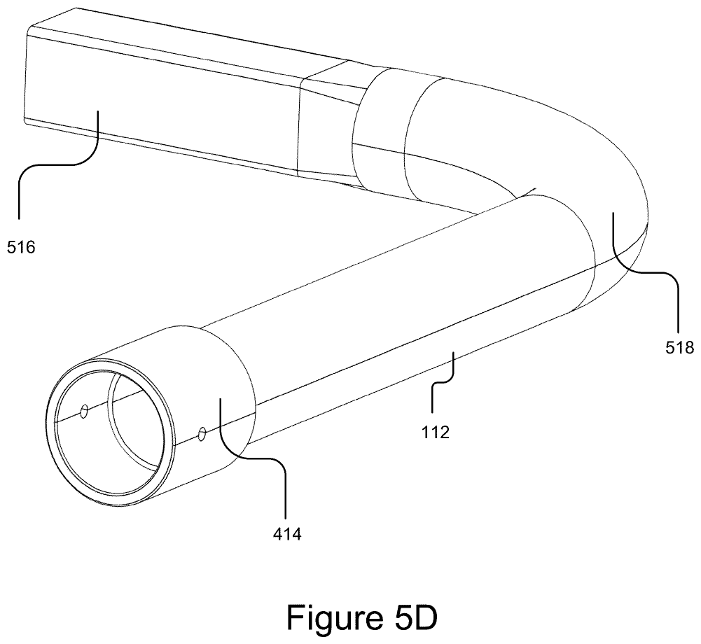

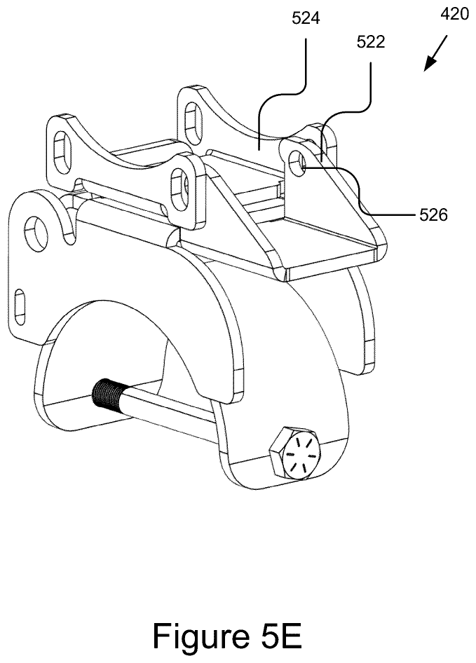

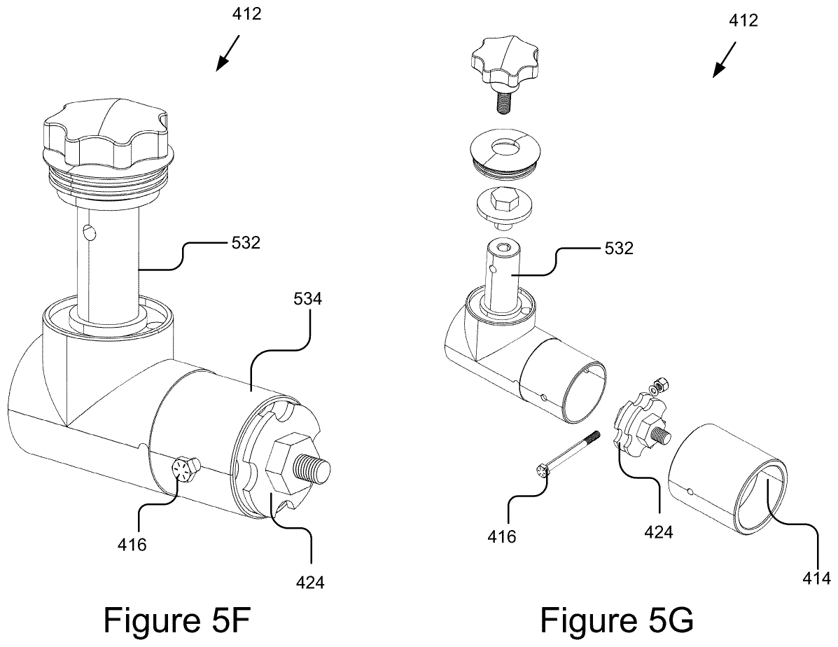

FIG. 4F illustrates the example reversible swing-arm system 108 in a right-handed configuration. In order to switch the swingarm between configurations, for example, between a left-handed configuration (e.g., shown in FIG. 4A) and a right-handed configuration (e.g., shown in FIG. 4F), the security bolt 416 may be removed (e.g., as shown in FIG. 4E) and then a coupling mechanism 424 may be decoupled (e.g., by loosening the bolt shown in FIG. 4E). The swing-arm assembly 108 (e.g., as shown in FIG. 5B) including the hitch arm 112 and the reversible hinge mechanism 412 may then be removed from the hitch arm. The hitch arm 112 may also be removed from the hitch receiver 304 of the vehicle (e.g., by removing a pin and pulling the hitch arm out of the hitch receiver 304) and rotated from facing the left side of the vehicle to facing the right side of the vehicle.

Once the hitch arm 112 is extending toward the right side of the vehicle, it may be re-inserted into the hitch receiver 304 and the hitch pin replaced. In some implementations, the swing lock 420 may be removed from the hitch arm 112 and replaced on its upward facing side to interact with the swing arm 114. For example, because the swing lock 420 may be bolted at the center of the hitch arm 112, as shown, it may be removed and replaced in the opposite orientation. In some implementations, the swing lock 420 may be placed on the bottom side of the swing arm 114 and configured to interact with either the top or bottom (depending on the orientation/handedness) of the hitch arm 112, so that it does not have to be removed to change orientations. Similarly, depending on the implementation, the swing lock 420 may have one or more stops or mechanisms that prevent it from being used in both orientations.

At this stage, the hitch arm 112 may be reinstalled into the hitch receiver 304 and pointed toward the right side of the vehicle. The swing arm assembly 512 may then be recoupled with the hitch arm 112, for example, by reinserting the reversible hinge mechanism 412 into the sleeve 414 of the hitch arm 112 while the riser 426 of the swing arm 114 remains pointed upward. The coupling mechanism 424 of the hinge mechanism may be coupled or tightened, and the security bolt 416 may be replaced.

In some implementations, the accessory clamps 422 or other devices may be removed from and replaced in the opposite position in order to switch their orientation(s) as well.

It should be noted that although this example process for changing orientations is described as being performed while attached to a vehicle, the components may be removed and replaced in the opposite orientation while separate from the vehicle. Similarly, other procedures may be used, for example, where other implementations of the reversible swing-arm system 108 are used.

As noted in reference to FIGS. 4A-4E illustrating various angles and positions of the reversible swing arm system in a left-handed orientation, FIGS. 4F-4H illustrate the system in a right-handed orientation. FIG. 4G illustrates the reversible swingarm system in a right-handed orientation viewed from a back side. As illustrated in FIG. 4G, the example accessory clamps may be positioned to face either away or toward the vehicle, depending on the implementation. Similarly, FIG. 4H shows the example reversible swingarm system 108 in a right-handed orientation and swung to an open position. As shown, the swing arm 114 has swung towards the right, which may be the right side of a vehicle on which it is mounted.

FIGS. 5A-5G illustrate various example components of the reversible swingarm system, according to some implementations. FIG. 5A illustrates an exploded view of the various components, although other components and features are possible and contemplated. The features shown in FIG. 5A may be described in further detail below and elsewhere in this description.

For example, a swing arm 114 is shown with a riser 426 and a hinge coupling portion 506 that allows the swing arm 114 to pivot or swing. For instance, the hinge coupling portion 506 may couple with a cylinder or axle of the reversible hinge mechanism 412. As noted elsewhere herein, the reversible hinge mechanism 412 may include a coupling mechanism 424 that interacts with a sleeve 414 and which may receive a security bolt 416 to lock it in place. A disassembled swing lock 420, accessory mount(s) 422, and various other bolts and components are shown. It should be noted that these are provided by way of example and that other implementations are possible, described, and contemplated herein.

FIG. 5B illustrates an example swing arm assembly 512 where a swing arm 114 is coupled with a reversible hinge mechanism 412. As illustrated, the swing arm assembly 512 is disconnected from a hitch arm 112, for example, as in a situation where the reversible swing arm system 512 is being changed between left and right configurations, as noted above. For instance, a hitch arm 112 may flip over in a hitch receiver 304 and the swing arm assembly 512 may be coupled with the hitch arm 112. The reversible hinge mechanism 412 also shows an example coupling mechanism 424, various implementations of which are described elsewhere herein.

As illustrated in FIG. 5B, the swing arm 114 may include a locking and/or support structure 514 on the riser 426 for coupling with a grill, kitchen, etc. For instance, the locking and/or support structure 514 may be symmetrical (as illustrated) or reversible so that the device(s) can be mounted and/or rotated in either orientation.

FIG. 5C illustrates an example swing arm 114, which may have a hinge coupling portion 506 that couples with a reversible hinge mechanism 412. For instance, the hinge coupling portion 506 may include an aperture at an end of the swing arm 114 through which a hinge or shaft of a hinge may extend and that couples with the reversible hinge mechanism 412. As illustrated, the swing arm 112, at the opposite end, may include a 90-degree angle that bends the swing arm up into a riser 426, as noted elsewhere herein. For instance, no matter the configuration (left- or right-handed), the riser 426 may extend upward when the reversible swing-arm system 108 is mounted to a vehicle, although other implementations are possible.

FIG. 5D illustrates an example hitch arm 112. The hitch arm 112 is illustrated with a hinge and swing arm 114 removed, such as when it is being switched between a right and left orientation. The hinge arm 112 may include a hitch receiver insert 516 that inserts into a hitch receiver 304 (not shown in FIG. 5D) of a vehicle in two or more orientations. For instance, the hitch arm 112 may extend to the right or to the left of the vehicle, as noted above. The hitch arm 112 may include an elbow 518 that bends to the left or right of the vehicle depending on the orientation.

In some implementations, an end of the hitch arm 112 may include one or more features for interacting with a removable, reversible hinge mechanism 412. For instance, the hitch arm 112 may include a sleeve 414 into which a corresponding portion of the hinge mechanism 412 may be inserted and/or coupled. For instance, a hinge mechanism 412 may be inserted into the sleeve 414 in two or more orientations and a coupling mechanism 424 may be used to couple these two parts together. In some implementations, the sleeve 414 may include bolt holes through which a security bolt 416 may pass, and which correspond to matching holes in the hinge mechanism 412. Although an example is illustrated in FIG. 5D, other implementations, such as of coupling mechanisms 424, etc., may be used, as noted elsewhere herein.

FIG. 5E illustrates an example swing lock 420. As illustrated, the swing lock 420 may include an interaction element 522 for locking a swing arm 114 with a hitch arm 112. For example, where the swing lock 420 is coupled with a hitch arm 112 to be between the hitch arm 112 and the swing arm 114 (e.g., on an upward oriented side of the hitch arm), it may lock the two arms together. The swing lock 420 may include a bolt that may be installed symmetrically through the hitch arm 112 to allow the swing lock 420 to be mounted/faced in either direction, so that it can be on a top/bottom of the hitch arm 112 and allow changeability between the right and left-handed orientations. In some implementations, the swing lock 420 may be mounted to a bottom of the swing arm 114 to interact with either side of the hitch arm 112.

As illustrated in the example of FIG. 5E, the swing lock 420 may include a receiving element 524 (e.g., mounted to a swing arm 114) that interacts with the interaction element 522 symmetrically to receive the interaction element 522 whichever it's orientation. The interaction element 522 may have a button or other structure that decouples the interaction element 522 from the receiving element 524. For instance, the interaction element 522 may be pressed downward to flex away from the receiving element 524. In some implementations, as illustrated in the example of FIG. 5E, the interaction element 522 and receiving element 524 may each include one or more through-holes 526 that may receive additional locking pins, padlocks, bolts, or other mechanisms for securing the swing lock 420 (e.g., securing the interaction element 522 to the receiving element 524).

FIG. 5F illustrates an example reversible hinge mechanism 412 and FIG. 5G illustrates an example reversible hinge mechanism 412 in an exploded view. The hinge mechanism 412 may include a vertical post 532 that forms part of a hinge with the swing arm 114, as noted above. The post 532 may include bolts, seals, gaskets, bearings, or other mechanisms that attach the post 532 with the swing arm 114.

In some implementations, the hinge mechanism 412 may include an extension 534 that may be inserted into the sleeve 414 of a hitch arm 112. The extension 534 may be inserted into the hitch arm 112 (whether or not there is a sleeve 414) to provide rigidity between the swing arm 114 and hitch arm 112.

In some implementations, the hinge mechanism 412 may include a coupling mechanism 424 (e.g., on the extension 534) that couples the hinge mechanism 412 with the hitch arm 112. For instance, the coupling mechanism 424 may be tightened (e.g., through an opposing end of the reversible hinge mechanism 412) to secure the hinge mechanism 412 to the hitch arm 112.

For example, the coupling mechanism 424 may include a bolt passing through multiple rings, bolts, or other devices, which may, for instance, be asymmetrical thereby allowing them to grasp the interior of a pipe (e.g., the sleeve 414 or hitch arm 114, etc.) and secure the components together.

In some implementations, the security bolt 416 may pass through the sleeve 414 and the extension 534 to secure them together and/or provide an extra layer of security.

It should be noted that although a certain configuration of the reversible hinge mechanism 412, such as the post/hinge portion, coupling mechanism 424, or other elements are illustrated, other implementations are possible and contemplated herein. For instance, the reversible hinge mechanism 412 may be any mechanism that allows the swing arm 114 to both pivot/swing relative to the hitch arm 112 while also allowing it to be coupled with the hitch arm 112 in either orientation.

FIGS. 6A-6F illustrate example implementations of a reversible swing-arm system 108. The illustrated examples may include variations to those others described herein; however, it should be noted that some or all of the components of the various implementations described herein may be exchanged, used together, or otherwise revised. For instance, various combinations and revisions are possible and contemplated and the set of implementations described herein are provided by way of example. Other implementations than the provided examples are also possible.

FIG. 6A illustrates a perspective view and FIG. 6B illustrates a side view of an example reversible swing-arm system 108 in a closed and left-handed configuration. As illustrated in the examples, the swing-arm system 108 may include another example implementation of a reversible hinge assembly 612. The reversible hinge assembly 612 may include another example implementation of a coupling mechanism 624, which may include a first mounting plate that is oriented to be perpendicular with a length of the hitch arm 112, as illustrated. It should be noted that other orientations and angles are possible. A hitch arm 112 may include a second mounting plate that couples with the first mounting plate to secure the reversible hinge assembly 612 to the hitch arm 112. For instance, a sleeve 614 may be coupled (e.g., welded, bolted, etc.) to a hitch arm 112 and may have the second mounting plate coupled, formed, or attached thereto.

Depending on the implementation, the first and second mounting plates may be symmetrical so that they can be coupled together in at least two directions, such as where the hitch arm 112 is rotated in either direction. For instance, the mounting plates may have a symmetrical pattern of through-holes through which bolts (potentially coupling with a loose or captive nut) may be placed to secure the mounting plates together and thereby secure the hitch arm 112 to the reversible hinge assembly 612.

In some implementations, similar to the description above, a security bolt 616 may further couple the reversible hinge assembly 612 to a hitch arm 112. For instance, a portion of the reversible hinge assembly 612 may extend into the sleeve 614 or hitch arm 112 and the security bolt 616 may extend through both components to further secure them together.

FIG. 6C illustrates a perspective view of an example hitch arm 112, which includes a sleeve 614 where the sleeve incorporates a mounting plate. An opposing end of the hitch arm 112 may be inserted into a hitch receiver (not shown in FIG. 6C).

FIG. 6D illustrates a perspective view of an example reversible hinge assembly 612. The example reversible hinge assembly 612 illustrated in FIG. 6D may be similar to but include a different coupling mechanism 424/624 than the reversible hinge assembly 412 illustrated in the example of FIGS. 5F and 5G. In the illustrated example, an extension 634 may be inserted into a sleeve 614 or hitch arm 112 and may receive a security bolt 616. It should be noted that the reversible hinge assembly 412 or 612 may be inverted and rotatable so that the extension 534 or 634 and coupling mechanism 424 or 624 interacts with a mounting plate or sleeve 614 on a swing arm 114.

The example coupling mechanism 624 may include a mounting plate 642 with through-holes that allow it to be bolted with a second mounting plate attached to the hitch arm 114. This configuration is beneficial as it is easily assembled in a secure and redundant manner.

The example coupling mechanism 624 also includes a vertical post 632 that interacts with a coupling portion 506 of a swing arm 114 (not shown in FIG. 6D) to allow the swing arm 114 to pivot about an axis formed by the post 632.

FIGS. 6E and 6F respectively illustrate a top-down view and an end view of the coupling mechanism 624. As illustrated in the example of FIG. 6E, a post 632 may include a bolt hole that allows a bolt to be placed therein to couple a swing arm 114 therein. Similarly, in the example of FIG. 6F, a post 632 may include one or more transverse holes that allow locking pins to be extended therethrough to lock positions or orientations of the swing-arm system 108.

As illustrated in FIG. 6F, an end of a coupling mechanism 624 may be an open tube or it may be closed on the end.

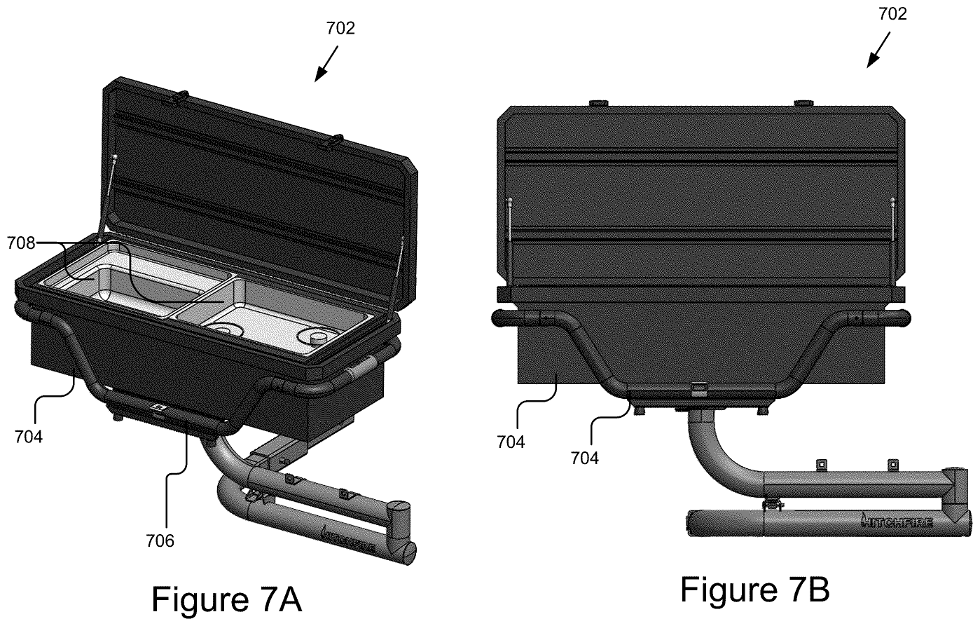

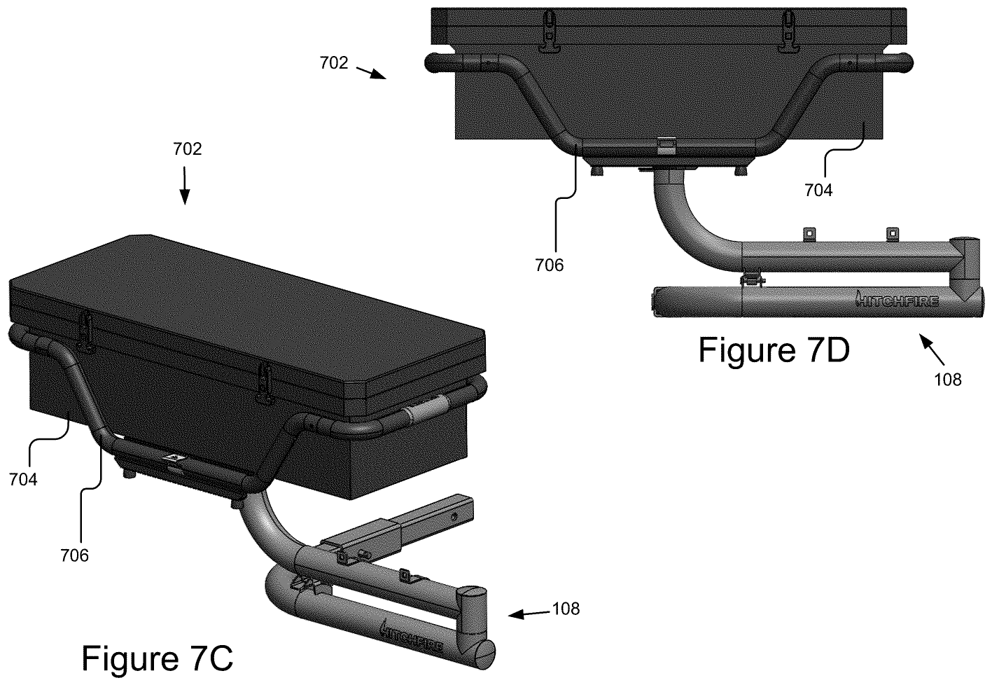

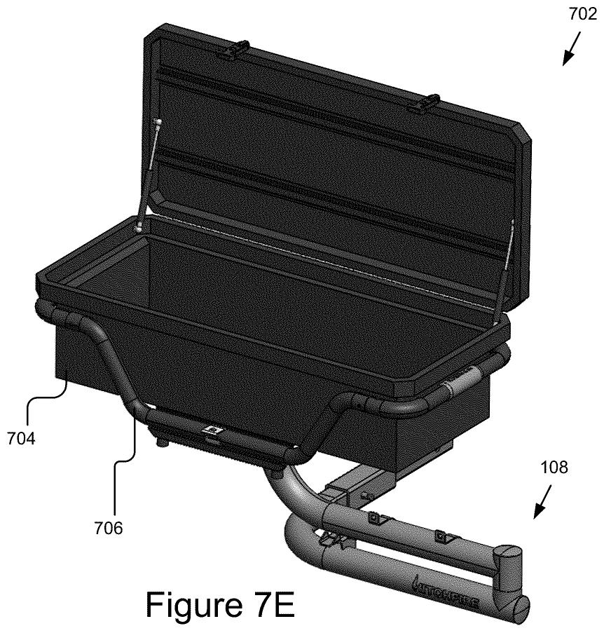

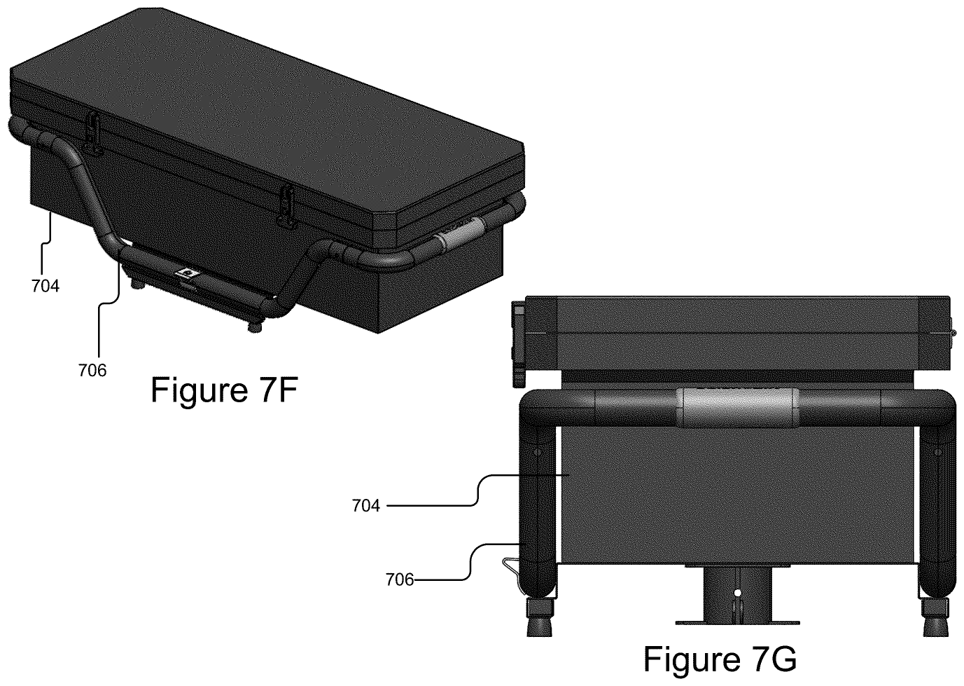

FIGS. 7A and 7B illustrate an example hitch-mounted adaptable kitchen system 702 (referred to herein as kitchen system 702) in an open position. As illustrated, the kitchen system 702 may include a case 704 mountable to a chassis/frame 706, such as the chassis/frame 106 described in reference to the grill system above. The case 704 may include a case body, which may have sides, a floor, and a lid. The lid may be closable via one or more latches and/or locks and may include strengthening channels, corrugations, etc., to provide strength and security while attached to a vehicle.

In some implementations, the case 704 may include an inner lip on which one or more accessories may rest or attach. For example, as illustrated, the kitchen system 702 may include various modules 708 mountable/placeable in the case 704 (e.g., on the lip or another mounting point). For instance, the kitchen system 702 may include a sink module, a burner module, a grill module, a storage module, a tool module, other modules, or combinations thereof. The case 704 may carry a single module, two modules, or other quantities or configurations.

FIGS. 7C and 7D illustrate the example kitchen system 702 with the lid closed. For instance, the lid of the case 704 may be closed using latches (e.g., T latches), locks, straps, etc. In some implementations, the lid may close with a seal around a contact path to provide water resistance and/or decrease rattling of the case/lid when a vehicle is in motion. In some instances, the lid may also exert a pressure on the module(s) therein to decrease movement of the module(s).

In some implementations, the chassis 706 and/or case may couple with the swing-arm system 108, mounting points, collar, tower, etc., as described in further detail in reference to the grill system 102.

FIG. 7E illustrates the kitchen system 702 without any accessory modules installed therein and in an open position. As illustrated, the case 704 of the kitchen system 702 may provide secure, additional storage mountable to a swing-arm system 108. For instance, the case 704 may provide 75 liters of storage or cooler space. Additionally, as illustrated, the lid may be held in an open position using gas rams or other devices.

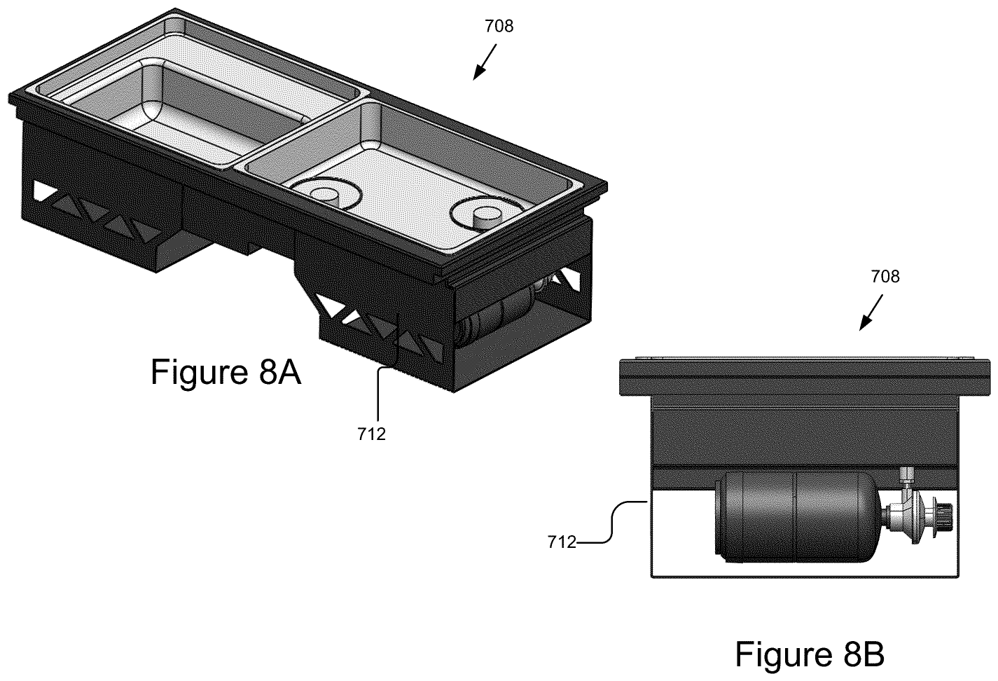

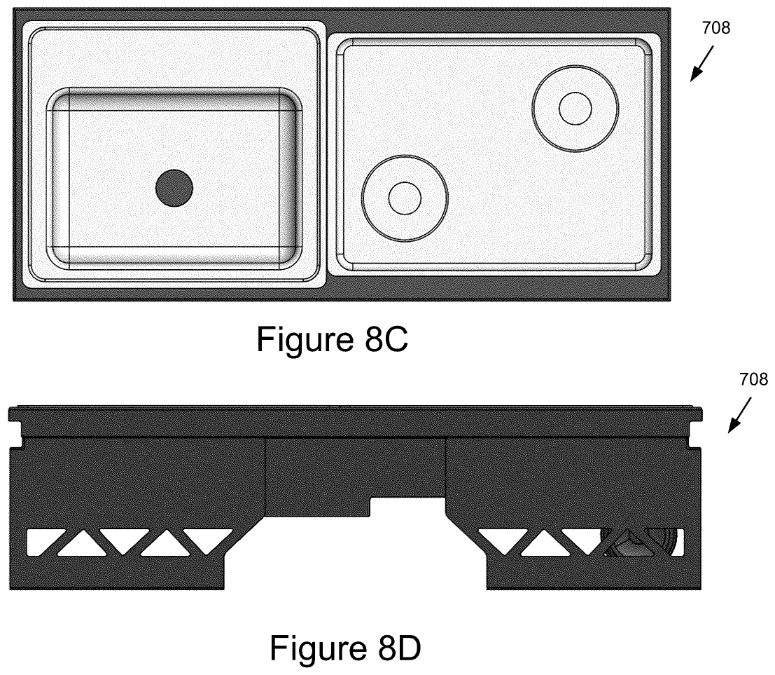

In some implementations, the case 704 of the kitchen system 702 may be removable either separately or while attached to the chassis/frame 706, for example, as illustrated in FIGS. 8A and 8B. For instance, the chassis/frame may remain attached to the swing-arm system 108 and other mechanisms may be attached thereto. In some implementations, the kitchen system 702 and the grill system 102 may interchangeably use the same frame/chassis 106 or 706, swing-arm system 108, or other devices. In some implementations, the chassis 706 may mount various other accessories via mounting holes, bolts, or other coupling mechanisms. For example, other mechanisms may be coupled with the chassis 706 and/or mounting point(s) of the swing-arm system 108, such as tables, cutting boards, tool holders, clamps, coolers, fish cleaning stations, etc.

In some implementations, as illustrated in FIGS. 7F and 7G, the case 704 (e.g., of the kitchen system 702) may be coupled with the chassis 706, which includes a collar for coupling the chassis with a swing-arm system 108, as described above in reference to the grill system 102. For example, the chassis 706 may provide strength, handles, and/or legs for the case or other components whether attached or detached from the swing-arm system 108.

For example, as illustrated in FIGS. 7F and 7G, the chassis 706 may include feet and/or legs that provide vertical support to the case and/or chassis 706 when removed from the swing-arm system 108. For example, one or more pins, bolts, locks, or other mechanisms may be used to attach and/or detach the chassis and/or case from the swing-arm system 108.

Inside dimensions of the case 704 may be approximately 36 inches long, 14 inches wide, and 10 inches deep. The figures provide example dimensions, although other implementations are possible and contemplated herein.

FIGS. 8A and 8B illustrate an example accessory module 708, which may be placed inside a case 704 and/or attached to a chassis/frame 706 or swing-arm system 108. As illustrated, the accessory module 708 may include a body 712, which may be constructed from plastic, composite, or perforated metal, for example, thereby providing support and/or insulation that allows the accessory module to be safely placed on a table (e.g., without transferring excessive heat to the table). The body 712 of the accessory module 708 may house various devices, such as a gas canister for burner(s) or a grill, a drain for the sink, a water reservoir for the sink, a water heater (e.g., either gas from the canister or electric), a water pump, storage, drawers, or other objects.

Depending on the implementation, the sink, burner(s), and/or grill may be removable from the module body 712. For example, the burner component may lift from the module body to provide access to the fuel canister. The size of the module 708 may be slightly smaller than the interior of the case 704, depending on the implementation.

The module body may additionally include various mechanisms for attaching it to the case 704, lifting (e.g., by handles) it from the case, or attaching it to other devices.

Although only a single module 708 is illustrated, in some implementations, the modules 708 may be divided into portions of the case, for instance, where two, three, or other quantities of modules 708 may be interchangeably held in the case 704.

FIGS. 8C and 8D respectively illustrate a top-down view and a side view of the example accessory module 708 where a sink is located to the left and burner section is located to the right, although other implementations are possible and contemplated. In some instances, the sink may include a drainpipe that passes through the case, through the module body, and/or into a reservoir.

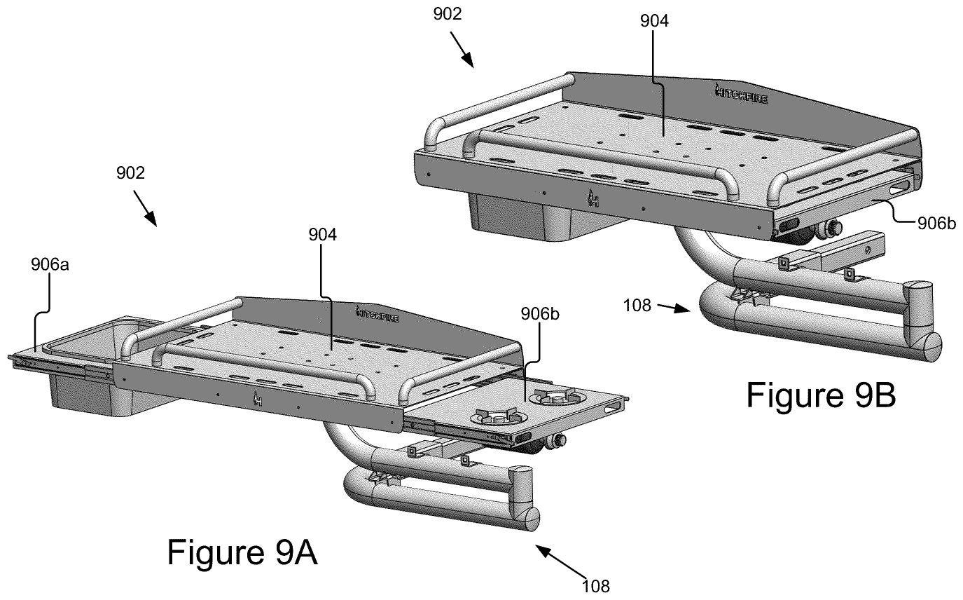

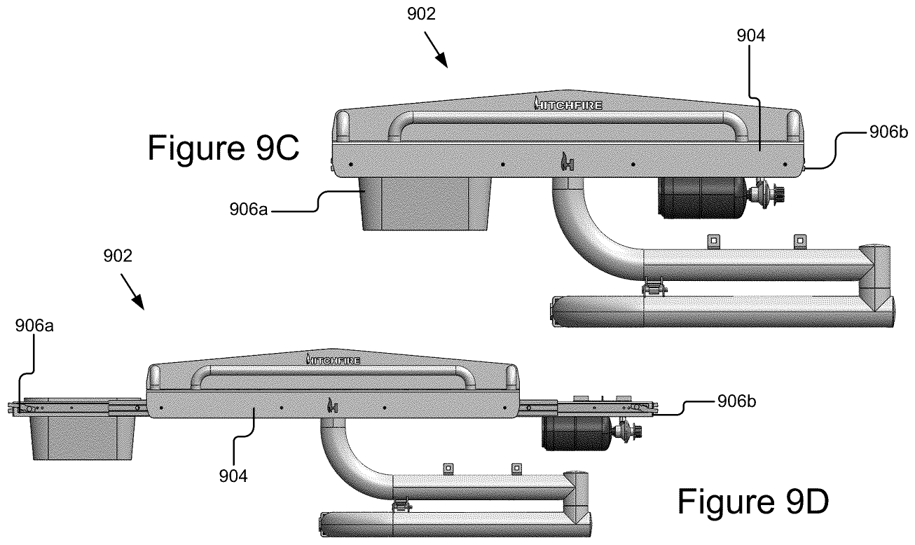

FIGS. 9A-9D illustrate example implementations of a hitch-mountable platform 902 with integrated sliding accessories (also referred to herein simply as the cook station). It should be noted that although certain configurations, features, and implementations are described and illustrated, some implementations of the technology may vary, for example, using other features described herein or otherwise.

FIGS. 9A-9D various views of an example platform 902, which may also be referred to as a cook station 902 herein. FIG. 9A illustrates the cook station 902 coupled with a swing arm assembly 108. For instance, a hitch arm 112 may be coupled to a vehicle, a swing arm 114 may be coupled with the hitch arm 112, and a tower of the swing arm 114 may be coupled with the cook station, similar to the above description. For instance, a tower of the swing arm 114 may be coupled with a friction collar, which friction collar may be bolted or welded to a platform via a bracket or support plate. The collar may allow the platform to be mounted, removed, rotated, or locked into a rotational orientation.

The cook station 902 may include a platform 904 with accessory side tables 906a and 906b. For instance, the slide tables 906 may be mounted to an underside of a body of the platform 904 via drawer slides. Further details are described below.

FIG. 9A illustrates the side tables 906 in an extended position where the side tables are slid out from under the platform 904. FIG. 9B illustrates the side tables 906 in a retracted position where they are stored under the platform 904.

As illustrated, a platform 904 may include a metal plate with reinforcing side walls and/or rails positioned above or below the surface of the platform 904. The side walls and/or rails may allow objects to be tied to the platform 904 and/or prevent objects from sliding off of the platform 904 when the vehicle is underway or parked on a slope. Although not visible in FIGS. 9A-9D, the cook station 902 may additionally or alternatively include an undercarriage or chassis that reinforces the cook station and/or allows the cook station to sit on a flat surface, such as a table.

The platform 904 may be mounted to a collar, as described elsewhere herein, that allows the platform 904 to be detachably coupled to the swing arm 114, for example, to switch it with the grill described elsewhere herein. The collar may include a quick release pin, bolt to tighten the collar, or other features that allow the cook station 902 to be rotated, for example, when the swing arm 114 is swung away from a vehicle.

The platform 904 may include perforations to allow it to be bolted to a collar, passthroughs, and/or other structures. For instance, the passthroughs may allow items to be tied to the platform or may allow ventilation or drainage.

The surface of the platform 904 may be designed to support items for storage, as a food preparation surface (e.g., with a cutting board or to which a magnetic cutting board mounts). In some implementations, the surface may additionally or alternatively be a cooking platform where, when a burner is slid under the platform 904, it may allow food to be cooked thereon.

The side tables 906 may extend between a front and a back of the platform 904 and slide horizontally therefrom. The platform 904 may have a front and back wall or apron to which the drawer slides of the side tables 906 are mounted. The slides, walls, platform or swing arm collar may include locks that lock the side tables into a stored/retracted and/or open position. Similarly, the slides may be removable/decouplable (e.g., an extendible portion thereof) to allow the side tables 906 to be removed and interchanged with various sliding tables 906 having other accessors, such as side tables that are flat, include a cutting board, have a grill surface, a skillet, a second sink, or otherwise.

In some implementations, a right sliding accessory table 906b may include one or multiple burners mounted thereto, so that the burners are on a top surface and there is sufficient clearance between a bottom surface of the platform 904 and the burners to allow the side table 906b to slide under the platform 904. Knobs that control the burners may also be coupled with the top surface of the table and slide under the platform 904, or they may be removed, etc. The burner(s) may be coupled with a gas canister that may be mounted to the swing arm 114, under the platform 904, or under the side table 906b. For example, as illustrated, the canister may be coupled horizontally with the bottom of the table 906b so that it does not contact the swing arm 114 when the cook station 902 is rotated or when the sliding side table 906b is retracted.

In some implementations, a side table 906a may include a sink or basin integrated therewith. The basin may include a drain at its bottom that may drain, for example, into an external bucket through a connectable tube. Additionally, or alternatively, the basin may include handles that allow it to be removed and dumped. The basin may be solid, insertable, or collapsible, for example to allow various depths and configurations. In some implementations, adjacent to the basin on the side table, the side table 906a may include a faucet that is connectable, foldable, or permanently attached. The faucet may include a manual, electric, or gravity fed pump. For instance, the table 906a may include an aperture through which a faucet is attached, or the faucet may be magnetically attached to a top or back surface of the side table 906a.

The side tables 906 may have a slide length (and/or the platform 904 may have a corresponding width) so that they slide under the platform 904 and are completely stored thereunder without hitting the collar, so that the cook station 902 may rotate regardless of whether the tables 906 are retracted or extended.

In some implementations, the platform 904 may include mounting points for additional accessories. For instance, the walls, rails, skirts/aprons, or other structures may include perforations, protrusions, hooks, or other devices. As illustrated, the accessory mounting points may include bolt holes through which accessories may be mounted, although other implementations are possible and contemplated. For instance, cup holders, a spice rack, a power towel holder, a bottle opener, or various other accessories may be mounted to or integrated with the platform 904.

FIGS. 9C and 9D illustrate an example implementation of the cook station 902 in a closed and open position, respectively. It should be noted that although the side tables 906 are shown as retracting horizontally under the platform 904 from the sides, they may alternatively extend from the front or back. Similarly, although two sliding tables 906 are shown, one, two, or more sliding tables 906 may be used that are smaller, larger, or positioned differently. In some implementations, the sliding tables 906 may be stacked in order to allow additional to be included.

An example insertable and collapsible sink basin may be used with a side table 906 where it inserts into a correspondingly shaped hole in the side table 906. In some instances, when the collapsible sink is inserted while the side table is retracted into the cook station/under the platform, the bottom surface of the platform may hold the collapsible sink from falling out of the hole/off the side table.

FIG. 9D also illustrates a side view of an example cook station showing a locking arm for the drawer slide of a side table, which allows the drawer to be locked in position. For example, 14-inch drawer slides that lock in a retracted and/or extended position may be used. Other lengths, sides, or configurations may be used.

Various measurements, and configurations of an example cook station 902 may be used. For instance, a platform 904 may have a width of approximately 38 inches, a depth of 21 inches, and a height of approximately 7 inches. A side table 906 may have a width of approximately 14 inches, a depth of approximately 20 inches, and a height of approximately 2 inches.

In some implementations, the cook station 902 may include a cupholder, a tray, and/or a paper towel holder mounted to accessory mounts on the front apron/wall of the platform 904. A cutting board may be included on the platform surface or an additional single cupholder may be mounted to a back wall of the cook station 902.

In the foregoing description, for purposes of explanation, numerous specific details are set forth in order to provide a thorough understanding of the technology. It will be apparent, however, that the technology described herein can be practiced without these specific details.

Reference in the specification to “one implementation”, “an implementation”, “some implementations”, or “other implementations” means that a particular feature, structure, or characteristic described in connection with the implementation is included in at least one implementation of the disclosure. The appearances of the term “implementation” or “implementations” in various places in the specification are not necessarily all referring to the same implementation.

In addition, it should be understood and appreciated that variations, combinations, and equivalents of the specific implementations, implementations, and examples may exist, are contemplated, and are encompassed hereby. The invention should therefore not be limited by the above-described implementations, implementations, and examples, but by all implementations, implementations, and examples, and other equivalents within the scope and spirit of the invention as claimed.

What is claimed is:

1. A reversible swing-arm system comprising:
a swing arm that pivots at a first end and includes one or more accessory mounting points toward a second end;
a hitch arm couplable with a hitch receiver of a vehicle in at least two orientations, the hitch arm having an elbow that extends to one or more of a left side and a right side of the vehicle when the hitch arm is coupled to the vehicle; and
a hinge mechanism coupled with the swing arm and allowing the swing arm to pivot about an axis of rotation formed by the hinge mechanism, the hinge mechanism being detachably coupleable with the hitch arm in the at least two orientations of the hitch arm.

2. The reversible swing-arm system of claim 1, wherein the swing arm includes:
a riser at the second end, the riser extending vertically upward when the reversible swing-arm system is mounted to the vehicle in each of the at least two orientations.

3. The reversible swing-arm system of claim 2, wherein the swing arm includes:
the one or more accessory mounting points integrated with the swing arm, the one or more accessory mounting points allowing one or more accessories to be mounted to the swing arm in addition to a device coupled with the swing arm at the riser.

4. The reversible swing-arm system of claim 1, wherein the swing arm includes a hinge coupling portion at the first end, the hinge coupling portion pivoting about a post integrated in the hinge mechanism and extending upward from the hitch arm when the reversible swing-arm system is mounted to the vehicle in each of the at least two orientations.

5. The reversible swing-arm system of claim 1, wherein the hitch arm inserts into the hitch receiver of the vehicle at a first end of the hitch arm and detachably couples with the hinge mechanism at a second end of the hitch arm.

6. The reversible swing-arm system of claim 5, wherein the elbow of the hitch arm statically maintains the hitch arm in a substantially L-shaped configuration.

7. The reversible swing-arm system of claim 1, wherein the hitch arm includes:
a sleeve at an end of the hitch arm into which a portion of the hinge mechanism inserts.

8. The reversible swing-arm system of claim 7, wherein:
the hinge mechanism includes a first hole;
the sleeve includes a second hole; and
the reversible swing-arm system includes a security bolt simultaneously extending through the first hole and the second hole to secure the hinge mechanism to the sleeve.

9. The reversible swing-arm system of claim 7, wherein the sleeve includes a first mounting plate oriented in a substantially perpendicular direction to a length of the sleeve, the first mounting plate detachably coupling with a second mounting plate of the hinge mechanism.

10. The reversible swing-arm system of claim 1, wherein:
the hitch arm includes a tube with a bend forming the elbow, the hitch arm including a first end that inserts into the hitch receiver of the vehicle and a second end that is detachably coupleable with the hinge mechanism;
the hinge mechanism is coupled with the swing arm in each of the at least two orientations in a configuration that causes a coupling mechanism of the hinge mechanism to be located vertically lower than the swing arm; and
the coupling mechanism is coupled with the second end of the hitch arm in each of the at least two orientations.

11. The reversible swing-arm system of claim 1, further comprising:
a storage container coupled with a vertical riser of the swing arm, the storage container including a case and a lid.

12. The reversible swing-arm system of claim 11, further comprising:
an accessory module inserted into the case of the storage container, the accessory module including a burner and a sink basin.

13. The reversible swing-arm system of claim 1, wherein:
the hitch arm includes a tube with a bend forming the elbow, the hitch arm including a first end that inserts into the hitch receiver of the vehicle and a second end that is detachably coupleable with the hinge mechanism.

14. The reversible swing-arm system of claim 1, further comprising:
a platform coupled with a vertical riser of the swing arm, the one or more accessory mounting points including the vertical riser; and
one or more side tables slidably coupled with the platform, the one or more side tables sliding under the platform in a storage position and sliding horizontally out from under the platform in a deployed position.

15. The reversible swing-arm system of claim 14, wherein the one or more side tables include an integrated gas burner.

16. A hitch-mountable system comprising:
a swing-arm system including:
a swing arm that pivots at a first end and includes one or more accessory mounting points toward a second end;
a hitch arm couplable with a hitch receiver of a vehicle in at least two orientations, the hitch arm having an elbow that extends to one or more of a left side and a right side of the vehicle when the hitch arm is coupled to the vehicle; and
a hinge mechanism coupled with the swing arm and allowing the swing arm to pivot about an axis of rotation formed by the hinge mechanism, the hinge mechanism being detachably coupleable with the hitch arm in the at least two orientations of the hitch arm; and
one or more accessories coupled with the swing-arm system at the one or more accessory mounting points, the one or more accessories including one or more of a storage container, a grill, a camp kitchen, and a horizontal platform forming a table.

17. The hitch-mountable system of claim 16, wherein the swing arm includes:
a riser at the second end, the riser extending vertically upward when the swing-arm system is mounted to the vehicle in each of the at least two orientations.

18. The hitch-mountable system of claim 16, wherein the hitch arm includes:
a sleeve at an end of the hitch arm into which a portion of the hinge mechanism inserts.

19. The hitch-mountable system of claim 18, wherein:
the hinge mechanism includes a first hole;
the sleeve includes a second hole; and
the swing-arm system includes a security bolt simultaneously extending through the first hole and the second hole to secure the hinge mechanism to the sleeve.

20. The hitch-mountable system of claim 18, wherein the sleeve includes a first mounting plate oriented in a substantially perpendicular direction to a length of the sleeve, the first mounting plate detachably coupling with a second mounting plate of the hinge mechanism.
